(19) United States
(12) Patent Application Publication
(10) Pub. No.: US 2017/0154307 A1
(43) Pub. Date: Jun. 1, 2017

(54) PERSONALIZED DATA-DRIVEN SKILL RECOMMENDATIONS AND SKILL GAP PREDICTION

(71) Applicant: Linkedln Corporation, Mountain View, CA (US)

(72) Inventors: ABHINAV MAURYA, PITTSBURGH, PA (US); RAHUL TELANG, SEWICKLEY, PA (US); SAI SUNDAR SELVAGANESAN, SUNNYVALE, CA (US)

(21) Appl. No.: 15/051,551

(22) Filed: Feb. 23, 2016

Related U.S. Application Data
(60) Provisional application No. 62/261,132, filed on Nov. 30, 2015.

(51) Int. Cl. G06Q 10/10; H04L 29/08; G06F 17/30

(52) U.S. Cl. CPC G06Q 10/1053; G06F 17/3053; H04L 67/306; G06F 17/30598; G06Q 50/01

(57) ABSTRACT

System and methods for generating personalized skill and learning recommendation are disclosed. A social networking system determines a list of skills not yet acquired by a first member. The social networking system determines a value associated with each skill. The social networking system selects one or more skills the list of skills based on the determined value of each skill. For each selected skill, the social networking system identifies at least one educational opportunity associated with learning the selected skill. The social networking system ranks the selected skills based on the determined value associate with each skill. The social networking system transmits a skill recommendation for an educational opportunity based on the selected skill rankings to a client system associated with the first member for display in a user interface.

### TECHNICAL FIELD

The disclosed example embodiments relate generally to the field of social networks and, in particular, to personalizing skill recommendations and predicting skill gaps.

### BACKGROUND

The rise of the computer age has resulted in increased access to personalized services online. As the cost of electronics and networking services drops, many services can be provided remotely over the Internet. For example, entertainment has increasingly shifted to the online space with companies such as Netflix and Amazon streaming television shows and movies to members at home. Similarly, electronic mail (e-mail) has reduced the need for letters to be physically delivered. Instead, messages are sent over networked systems almost instantly.

Another service provided over networks is social networking. Large social networks allow members to connect with each other and share information. One such type of information is information about members' jobs, careers, education, and goals. Social networks enable members to share and view information about their careers and skills. Using that information, a social network can provide learning and employment opportunities.

### DESCRIPTION OF THE DRAWINGS

Some example embodiments are illustrated by way of example and not limitation in the figures of the accompanying drawings, in which:

FIG. 1 is a network diagram depicting a client-server system that includes various functional components of a social networking system, in accordance with some example embodiments.

FIG. 2 is a block diagram illustrating a client system, in accordance with some example embodiments.

FIG. 3 is a block diagram illustrating a social networking system, in accordance with some example embodiments.

FIG. 4 depicts a block diagram of an exemplary data structure for the member profile data for storing member profiles in accordance with some example embodiments.

FIGS. 5A-5B are user interface diagrams illustrating an example of a user interface or web page that displays a plurality of skill recommendations in response to selection of the skills tab.

FIG. 6 is a graph representing a plurality of members and the skills that each of them possess.

FIGS. 7A-7C are flow diagrams illustrating a method, in accordance with some example embodiments, for grouping jobs and members into buckets that allow more efficient comparisons to be conducted.

FIGS. 8A-8E are flow diagrams illustrating a method, in accordance with some example embodiments, for personalizing skill recommendations to members of a social networking system.

FIGS. 9A-9F are flow diagrams illustrating a method, in accordance with some example embodiments, for personalizing skill recommendations to members of a social networking system.

FIG. 10 is a block diagram illustrating an architecture of software, which may be installed on any one or more devices, in accordance with some example embodiments.

FIG. 11 is a block diagram illustrating components of a machine, according to some example embodiments.

Like reference numerals refer to corresponding parts throughout the drawings.

### DETAILED DESCRIPTION

The present disclosure describes methods, systems, and computer program products for providing improved skill recommendations for members, and predicting skill gaps at various granularity levels such as cities or industries. In the following description, for purposes of explanation, numerous specific details are set forth to provide a thorough understanding of the various aspects of different example embodiments. It will be evident, however, to one skilled in the art, that any particular example embodiment may be practiced without all of the specific details and/or with variations, permutations, and combinations of the various features and elements described herein.

In some example embodiments, a social networking system stores a large amount of data including member profiles with member skills data and job listing data. The social networking system can leverage this data to generate personalized skill recommendations. Personalized skill recommendations are recommendations for which skills a member should acquire and the means by which the member should acquire them. Skill gap is the gap between the skills demanded by jobs and the skills supplied by members of the workforce at a particular granularity level such as a city or an industry.

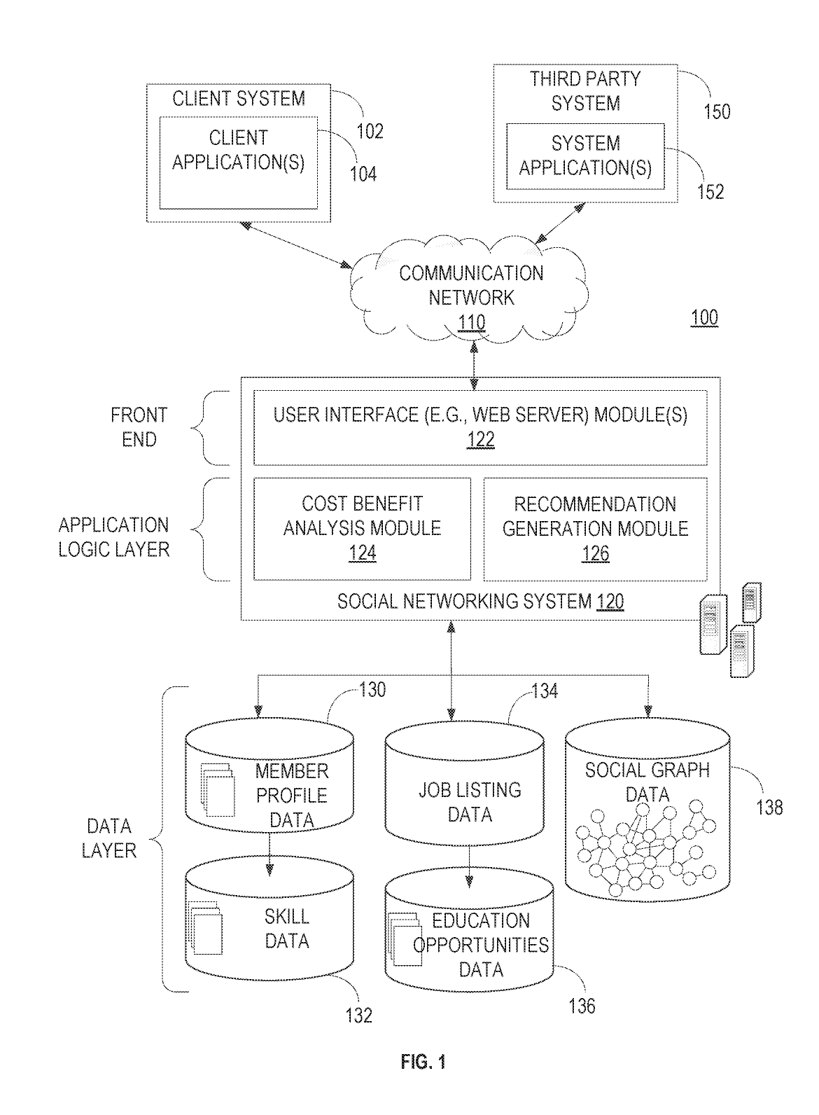

The personalized recommendations are data-driven, in that they use the massive amount of data available on the social networking system to most accurately estimate the effect of learning one or more skills and then the social networking system is able to follow the results of members who learn new skills based on the recommendations. The social networking system (e.g., system 120 in FIG. 1) uses data about each member to personalize recommendations such that the network recommends the skill that provides the most utility to a specific member at a specific time.

The social networking system first identifies a list of skills associated with the candidate member (e.g., the member for whom the recommendation is generated). In some example embodiments, the social networking system (e.g., system 120 in FIG. 1) determines the candidate member's field of expertise, educational qualifications, professional experience, and/or career path. Based on the candidate member's current skills, career path, field, qualifications, and experience, the social networking system (e.g., system 120 in FIG. 1) determines one or more potential skills for recommendation to the candidate member.

For each potential skill in the list of one or more potential skills, the social networking system (e.g., system 120 in FIG. 1) determines the overall utility of the skill to the candidate member. Determining overall utility includes determining the estimated benefit of the skill to the member and comparing the estimated benefit to the cost of learning the skill to the member.

In some example embodiments, the benefit of learning the skill is estimated by comparing the number and quality of employment opportunities available to the member with the member's current set of skills. Once the original number and quality of employment opportunities are determined, the social networking system can project the number and quality of employment opportunities available if the member were to learn a given skill. The difference between the quality and number of employment opportunities originally available and the quality and number of employment opportunities available with the proposed skill is the estimated level of benefit for that skill.

In some example embodiments, the cost of learning the skill is the estimated amount of time, money, opportunity cost, and so on that a member would have to use to acquire the skill. In some example embodiments, the social networking system can use existing estimates of skill acquisition time and costs of specific courses and/or training to estimate the cost.

In some example embodiments, the social networking system identifies a plurality of members, each of whom has at least one skill in common with the first member. The social networking system then determines, for each potential skill, the number of members in the plurality of members who have that skill. The social networking system determines that the greater the number of members in the plurality of members that have a certain skill, the less cost needed from the member to acquire that skill.

For example, the social networking system determines that there are twenty members who share skills with Member A. Of those twenty, eighteen have skill B but only two have skill C, the social networking system (e.g., system 120 in FIG. 1) estimates that skill C is harder to acquire than skill B (based on skill C's relative rarity).

In some example embodiments where estimation of the cost is difficult, the social networking system can match a member to a plurality of members similar to him in terms of demographic features, educational qualifications, professional experience, and already acquired skills. It can then limit the set of recommendable skills to skills that the member does not yet have but the plurality of members similar to him does, and assume the acquisition costs of these skills to be low enough so as to be negligible when compared to the benefit gained from the acquisition of the skill.

Once the social networking system has determined each skill's cost and benefit, the social networking system ranks each skill based on the skill's total value to the member. In some example embodiments, the social networking system also ranks skills based on their applicability to the member's current field of expertise or career.

In some example embodiments, the social networking system selects one or more skills with high value to the member. For each selected skill, the social networking system identifies one or more skill acquisition opportunities. Skill acquisition opportunities include courses, degrees, training, online tutorials, and so on.

The social networking system transmits the recommendations for display in a user interface at the client system. Each recommendation includes information for accessing the suggested educational opportunity (e.g., a link to the website or sign-up form).

In some example embodiments, skill recommendations on the basis of the number and quality of employment opportunities capture the demand of skills by jobs in the labor market. In contrast to this utility-based skill recommendation, the social networking system can make similarity-based recommendations using the traditional collaborative filtering approach, which recommends skills to a member that a plurality of members similar to him have already acquired. These latter recommendations capture the supply of skills by members in the labor market.

By comparing the number of times a skill was recommended in the utility-based recommendation system and the traditional similarity-based recommendation system at a certain level of granularity such as a city or industry, the social networking system can determine if the skill has a demand in the labor market that is not met by the supply from members at that level of granularity. On the basis of this comparison, it can assign each skill a skill gap score at the particular level of granularity, and rank skills on this score to produce a ranked list of skills indicating the importance of a skill to public policy and educational institutions as evidenced by the demand of the skill in the employment opportunities and the lack of supply of the skill by members of the workforce.

FIG. 1 is a network diagram depicting a client-social networking environment 100 that includes various functional components of a social networking system 120, in accordance with some example embodiments. The client-social networking system environment 100 includes one or more client systems 102 and a social networking system 120. One or more communication networks 110 interconnect these components. The communication networks 110 may be any of a variety of network types, including local area networks (LANs), wide area networks (WANs), wireless networks, wired networks, the Internet, personal area networks (PANs), or a combination of such networks.

In some example embodiments, a client system 102 is an electronic device, such as a personal computer (PC), a laptop, a smartphone, a tablet, a mobile phone, or any other electronic device capable of communication with a communication network 110. The client system 102 includes one or more client applications 104, which are executed by the client system 102. In some example embodiments, the client application(s) 104 include one or more applications from a set consisting of search applications, communication applications, productivity applications, game applications, word processing applications, or any other useful applications. The client application(s) 104 include a web browser. The client system 102 uses a web browser to send and receive requests to and from the social networking system 120 and displays information received from the social networking system 120.

In some example embodiments, the client system 102 includes an application specifically customized for communication with the social networking system 120 (e.g., a LinkedIn iPhone application), in some example embodiments, the social networking system 120 is a server system that is associated with a social networking service. However, the social networking system 120 and the server system that actually provides the social networking service may be completely distinct computer systems.

In some example embodiments, the client system 102 sends a request to the social networking system 120 for a webpage associated with the social networking system 120. For example, a member uses a client system 102 to log into the social networking system 120 and clicks a link to view a job listing for a job they are interested in from the social networking system 120. In response, the client system 102 receives the requested job listing data (e.g., data describing the position, the associated organization, the job requirements, and responsibilities) and displays that data in a user interface on the client system 102.

In some example embodiments, as shown in FIG. 1, the social networking system 120 is generally based on a three-tiered architecture, consisting of a front-end layer, application logic layer, and data layer. As is understood by skilled artisans in the relevant computer and Internet-related arts, each module or engine shown in FIG. 1 represents a set of executable software instructions and the corresponding hardware (e.g., memory and processor) for executing the instructions. To avoid unnecessary detail, various functional modules and engines that are not germane to conveying an understanding of the various example embodiments have been omitted from FIG. 1. However, a skilled artisan will readily recognize that various additional functional modules and engines may be used with a social networking system 120, such as that illustrated in FIG. 1, to facilitate additional functionality that is not specifically described herein. Furthermore, the various functional modules and engines depicted in FIG. 1 may reside on a single server computer or may be distributed across several server computers in various arrangements. Moreover, although depicted in FIG. 1 as a three-tiered architecture, the various example embodiments are by no means limited to this architecture.

As shown in FIG. 1, the front end consists of a user interface module (e.g., a web server) 122, which receives requests from various client systems 102 and communicates appropriate responses to the requesting client systems 102. For example, the user interface module(s) 122 may receive requests in the form of Hypertext Transport Protocol (HTTP) requests, or other web-based, application programming interface (API) requests. The client system 102 may be executing conventional web browser 106 applications or applications that have been developed for a specific platform to include any of a wide variety of mobile devices and operating systems.

As shown in FIG. 1, the data layer includes several databases, including databases for storing data for various members of the social networking system 120, including member profile data 130, skill data 132 (e.g., data describing the skills of one or more members of the social networking system 120), job listing data 134 (e.g., data describing one or more available jobs including the job title, requirements, and responsibilities), educational opportunities data 136, and social graph data 138, which is data stored in a particular type of database that uses graph structures with nodes, edges, and properties to represent and store data. Of course, with various alternative example embodiments, any number of other entities might be included in the social graph (e.g., companies, organizations, schools and universities, religious groups, non-profit organizations, governmental organizations, non-government organizations (NGOs), and any other group) and, as such, various other databases may be used to store data corresponding with other entities.

Consistent with some example embodiments, when a person initially registers to become a member of the social networking system 120, the person will be prompted to provide some personal information, such as his or her name, age (e.g., birth date), gender, contact information, home town, address, educational background (e.g., schools, majors, etc.), current job title, job description, industry, employment history, skills, professional organizations, memberships with other online service systems, and so on. This information is stored, for example, in the member profile data 130.

In some example embodiments, the member profile data 130 includes skill data. 132. In other example embodiments the member skill database 132 is distinct from, but associated with, the member profile database 130. The member skill database 132 stores skill data for each member of the social networking system (e.g., system 120 in FIG. 1). Skills stored in the member skill database 132 include both explicit skills and implicit skills.

In some example embodiments explicit skills are skills that the member is determined to have based on skill information directly received from the member. For example, a member reports that they have skills in using the C++, Java, PHP, CSS, and Python programming languages. Because the member directly reported these skills they are considered explicit skills. In some example embodiments explicit skills are listed on a member's public profile.

In some example embodiments one or more skills are determined based on an analysis of the non-skill data stored in a member profile. Skills determined in this way are considered implicit skills. Implicit skills are determined or inferred by analysing data stored in a member profile, including but not limited to education, job history, hobbies, friends, skill ratings, interests, projects a member has worked on, activity on the social networking system (e.g., system 120 in FIG. 1), and member submitted comments. In some example embodiments implicit skills may also be called inferred skills or skills a member may have. For example, member A lists an undergraduate degree in architecture and has a past job history that includes Project Architect for at least three different projects. The system 120 determines that member A has skill in AutoCAD even though the member has not directly reported having that skill. In some example embodiments implicit skills are not listed on a member's public profile.

The job listing data 134 stores data related to one or more job listings. Job listings are created in response to a request from a member or organization to list a job opening on the social networking system (e.g., system 120 in FIG. 1). Job listings include, but are not limited to, the job title, the job role, a description of the job requirements, a description of the job responsibilities, compensation data, skills associated with the job, the organization associated with the job, the specific location of the job, one or more potential evaluators for the job, one or more teams within an organization with which the job is associated, and one or more members who are likely coworkers associated with the job.

The educational opportunities data 136 includes a listing of educational opportunities available. Each educational opportunity is associated with one or more skills and a rating describing the level of proficiency that a member is expected to gain after completing the educational opportunity. Educational opportunities include degrees, courses (both online and in person), training programs, self-learning programs, lectures, and so on. In some example embodiments, each educational opportunity includes an estimated cost in time and money. In some example embodiments, at least some of the educational opportunity data is provided by an educational institution such as a university or college.

Once registered, a member may invite other members, or be invited by other members, to connect via the network service. A “connection” may include a bi-lateral agreement by the members, such that both members acknowledge the establishment of the connection. Similarly, with some example embodiments, a member may elect to “follow” another member. In contrast to establishing a “connection,” the concept of “following” another member typically is a unilateral operation and, at least with some example embodiments, does not include acknowledgement or approval by the member that is being followed. When one member follows another, the member who is following may receive automatic notifications about various interactions undertaken by the member being followed. In addition to following another member, a member may elect to follow a company, a topic, a conversation, or some other entity, which may or may not be included in the social graph. Various other types of relationships may exist between different entities and are represented in the social graph data 138.

The social networking system 120 may provide a broad range of other applications and services that allow members the opportunity to share and receive information, often customized to the interests of the member. In some example embodiments, the social networking service may include a photo sharing application that allows members to upload and share photos with other members. As such, at least with some example embodiments, a photograph may be a property or entity included within a social graph. With some example embodiments, members of a social networking service may be able to self-organize into groups, or interest groups, organized around a subject matter or topic of interest. In some example embodiments, the data for a group may be stored in a database. When a member joins a group, his or her membership in the group will be reflected in the organization interaction data, the member interaction data, and the social graph data 138.

In some example embodiments, the application logic layer includes various application server modules, which, in conjunction with the user interface module(s) 122, generate various user interfaces (e.g., web pages) with data retrieved from various data sources in the data layer. With some example embodiments, individual application server modules are used to implement the functionality associated with various applications, services, and features of the social networking service. For instance, a messaging application, such as an email application, an instant messaging application, or some hybrid or variation of the two, may be implemented with one or more application server modules. Similarly, a search engine enabling members to search for and browse member profiles may be implemented with one or more application server modules. Of course, other applications or services that utilize a cost benefit analysis module 124 or a recommendation generation module 126 may be separately implemented in their own application server modules.

In addition to the various application server modules, the application logic layer includes the cost benefit analysis module 124 or the recommendation generation module 126. As illustrated in FIG. 1, with some example embodiments, the cost benefit analysis module 124 or the recommendation generation module 126 are implemented as services that operate in conjunction with various application server modules. For instance, any number of individual application server modules can invoke the functionality of the cost benefit analysis module 124 or the recommendation generation module 126. However, with various alternative example embodiments, the cost benefit analysis module 124 or the recommendation generation module 126 may be implemented as their own application server modules such that they operate as stand-alone applications. With some example embodiments, the cost benefit analysis module 124 or the recommendation generation module 126 includes or have an associated publicly available API that enables third-party applications to invoke the functionality they provide.

Generally, the cost benefit analysis module 124 is accessed when evaluating the net benefit of a particular skill on a candidate member's ability to find a quality job. Thus, when determining which of a plurality of skills to recommend, the social networking system 120 first determines the benefit of adding the skill For example, the social networking system 120 determines the number and quality of job opportunities available to the candidate member with the current set of skills and compares it to the estimated number and quality of job opportunities available to the candidate member with a potential skill.

The determined increase in number and quality of job opportunities represents the benefit of the potential skill. The cost benefit analysis module 124 also determines a cost of the skill. In some example embodiments, the cost of skills is measured in an amount of currency, a period of time, opportunity cost, and time away from a job. In other example embodiments, the cost of an education opportunity can be estimated by the proportion of a candidate member's peer group (based on their skills) that has the potential skill. Skills that are commonly held are estimated to be easier to obtain than rare skills.

The cost benefit analysis module 124 calculates the difference between the estimated benefit and the estimated cost to arrive at the total value of learning the skill to the candidate member.

Once a value has been determined for each skill in a plurality of potential skills, the recommendation generation module 126 ranks the skills based on the determined values and the degree to which the skills are related to the candidate member's current career path or realm. In this way an easy to learn skill that is unrelated to a member's current job will be ranked behind a useful skill that is slightly more difficult to learn.

The recommendation generation module 126 selects one or f the top ranked skills and determines, based on the information in the educational opportunities data 136, educational opportunities available to the candidate member that can provide the most valuable skills. In some example embodiments, the recommendation generation module 126 transmits the recommendations to the client system (e.g., the client system 102 in FIG. 1) for display.

In some example embodiments, a third party system 150 connects to the social networking system (e.g., system 120 in FIG. 1) via the communication network 110. In some example embodiments, the third party system 150 is associated with an educational institution (e.g., a university, college, online learning website, and so on). The third party system 150 includes one or more system applications 152. In some example embodiments, the one or more system applications 152 provide details about educational opportunities to the social networking system (e.g., system 120 in FIG. 1) include class times, class costs, skills included, and so on.

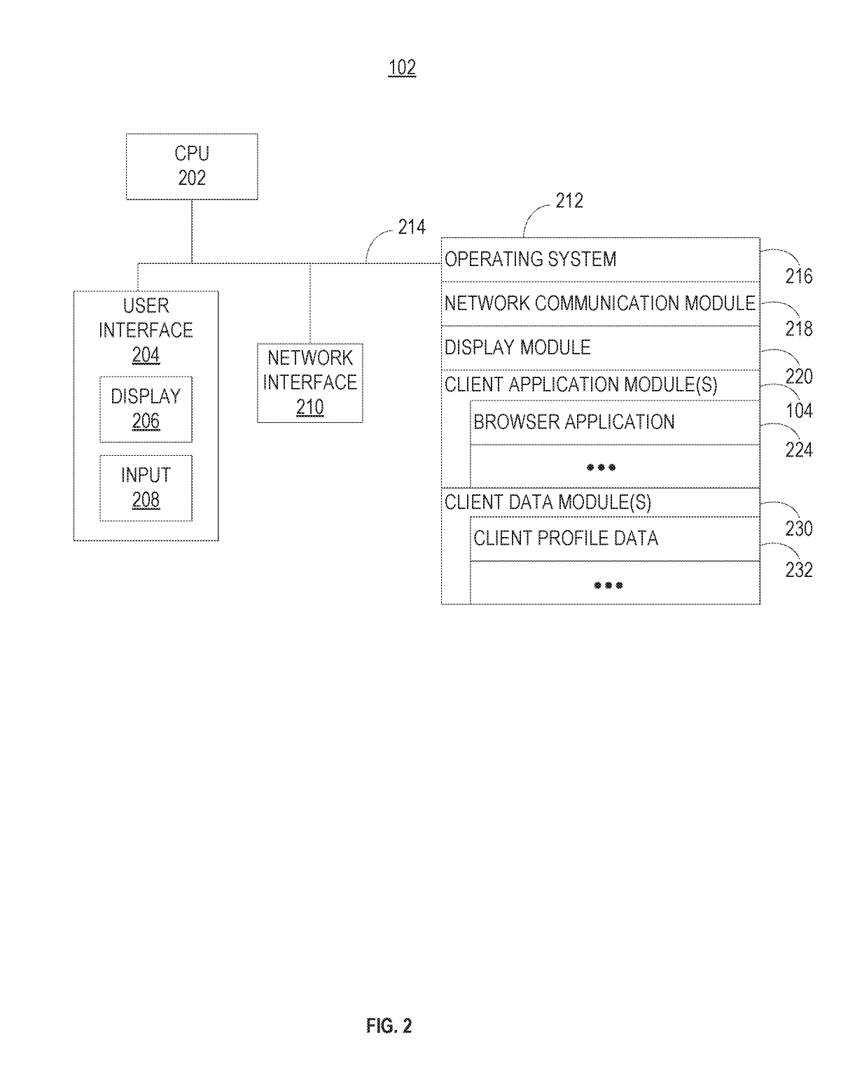

FIG. 2 is a block diagram further illustrating the client system 102, in accordance with some example embodiments. The client system 102 typically includes one or more central processing units (CPUs) 202, one or more network interfaces 210, memory 212, and one or more communication buses 214 for interconnecting these components. The client system 102 includes a user interface 204. The user interface 204 includes a display device 206 and optionally includes an input means such as a keyboard, mouse, a touch sensitive display, or other input buttons 208. Furthermore, some client systems 102 use a microphone and voice recognition to supplement or replace the keyboard.

Memory 212 includes high-speed random access memory, such as dynamic random-access memory (DRAM), static random access memory (SRAM), double data rate random access memory (DDR RAM) or other random access solid state memory devices; and may include non-volatile memory, such as one or more magnetic disk storage devices, optical disk storage devices, flash memory devices, or other non-volatile solid state storage devices. Memory 212 may optionally include one or more storage devices remotely located from the CPU(s) 202. Memory 212, or alternately, the non-volatile memory device(s) within memory 212, comprise(s) a non-transitory computer-readable storage medium.

In some example embodiments, memory 212, or the computer-readable storage medium of memory 212, stores the following programs, modules, and data structures, or a subset thereof:
an operating system 216 that includes procedures for handling various basic system services and for performing hardware-dependent tasks;
a network communication module 218 that is used for connecting the client system 102 to other computers via the one or more communication network interfaces 210 (wired or wireless) and one or more communication networks 110, such as the Internet, other WANs, LANs, metropolitan area networks (MANs), etc.;
a display module 220 for enabling the information generated by the operating system 216 and client application(s) 104 to be presented visually on the display device 206;
one or more client applications 104 for handling various aspects of interacting with the social networking system 120 (FIG. 1), including but not limited to:
   a browser application 224 for requesting information from the social networking system 120 (e.g., job listings) and receiving responses from the social networking system 120; and
client data module(s) 230 for storing data relevant to the clients, including but not limited to:
   client profile data 232 for storing profile data related to a member of the social networking system 120 associated with the client system 102.

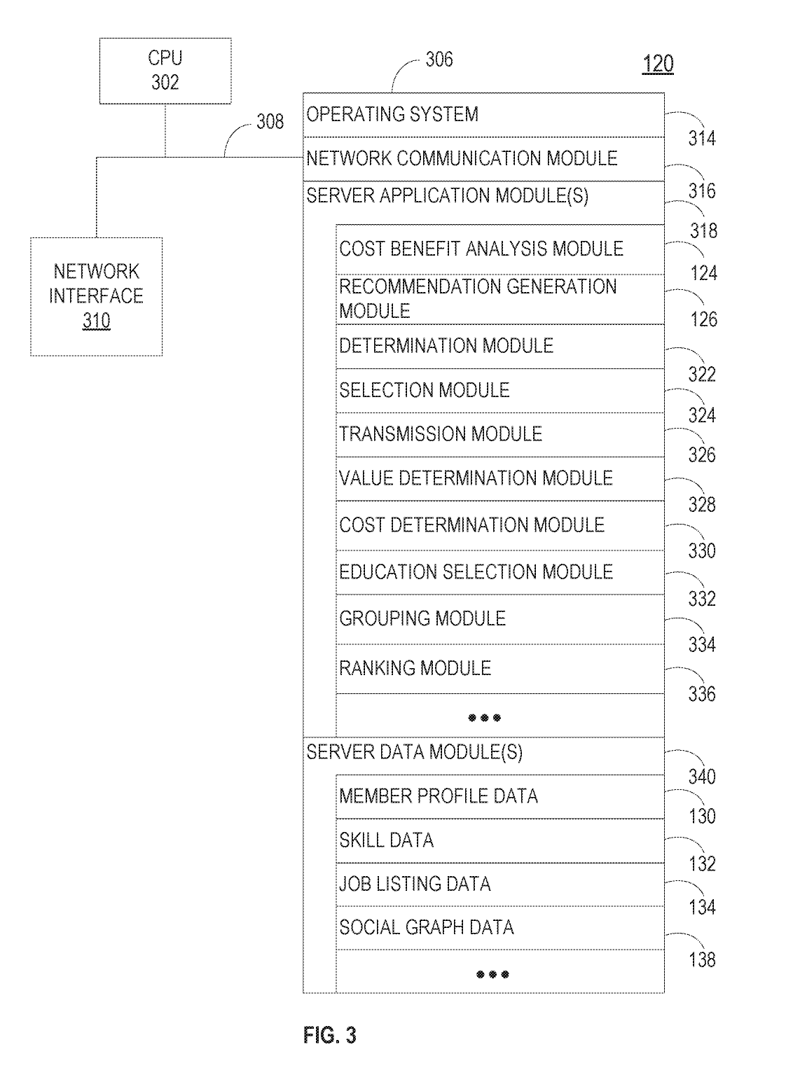

FIG. 3 is a block diagram further illustrating the social networking system 120, in accordance with some example embodiments. Thus, FIG. 3 is an example embodiment of the social networking system 120 in FIG. 1. The social networking system 120 typically includes one or more CPUs 302, one or more network interfaces 310, memory 306, and one or more communication buses 308 for interconnecting these components. Memory 306 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 306 may optionally include one or more storage devices remotely located from the CPU(s) 302.

Memory 306, or alternately the non-volatile memory device(s) within memory 306, comprises a non-transitory computer-readable storage medium. In some example embodiments, memory 306, or the computer-readable storage medium of memory 306, stores the following programs, modules, and data structures, or a subset thereof:
an operating system 314 that includes procedures for handling various basic system services and for performing hardware-dependent tasks;
a network communication module 316 that is used for connecting the social networking system 120 to other computers via the one or more communication network interfaces 310 (wired or wireless) and one or more communication network 110, such as the Internet, other WANs, LANs, MANs, and so on;
one or more server application modules 318 for performing the services offered by the social networking system 120, including but not limited to:
   a cost benefit analysis module 124 for determining, for a particular skill, the net value of learning that skill by estimating the benefit of learning a skill (e.g., based on increased access to quality jobs) and estimating the cost of learning a skill (e.g., in time, money, and so on);
   a recommendation generation module 126 for ranking one or more skills based on a calculated net value and skill relevance rating, selecting one or more highly ranked skills to recommend to a candidate member, determining one or more educational opportunities available to the candidate members, and communicating the recommended skills and associated educational opportunities to the client system (e.g., the client system 102 in FIG. 1) associated with the candidate member for display;
   a determination module 322 for determining one or more educational opportunities associated with a particular skills, for determining a value of each potential skill, determining an original number of educational opportunities available to a member and a supplemented number of educational opportunities available to a member, and determining the number of members who possess skills similar to those possessed by the candidate member and at least one of the potential skills;
   a selection module 324 for selecting a skill with the highest net benefit to a candidate member based on estimated benefits and estimated costs of the various potential skills;
   a transmission module 326 for transmitting or communicating one or more recommendations including both a skill to learn and an educational opportunity from which to learn it to a client system (e.g., the client system 102 in FIG. 1) for display in a user interface associated with the social networking system (e.g., system 120 in FIG. 1) to the candidate member;
   a value determination module 328 for estimating the value of a particular skill for a candidate member by determining the number and quality of employment opportunities available to the candidate member prior to learning the particular skill and the estimated number and quality of employment opportunities that would be available to the candidate member if the member learned the particular skill;
   a cost determination module 330 for estimating a cost of acquiring skills based both on listed time and currency requirements and the relative rarity of skills in a peer group of members (e.g., wherein a skill being very rare in members similar to the composite member is indicative of the skills being relatively difficult for the candidate member to acquire);
   an education selection module 332 for determining an optimal educational opportunity for a candidate member to gain proficiency in a particular skill based on a database of educational opportunities and the skills they provide;
   a grouping module 334 for grouping members together based on a number of factors including but not limited to educational history, industry area (e.g., based on a stored industry identification number), current or most recent company, titles, experience, educational institutions attended, and so on; and
   a ranking module 336 for ranking a plurality of particular potential skills based on a calculated net value to a candidate member of learning a particular potential skill, the current career path, and interests of the candidate member; and
server data module(s) 340, holding data related to social networking system 120, including but not limited to:
   member profile data 130 including both data provided by the member who will be prompted to provide some personal information, such as his or her name, age (e.g., birth date), gender, interests, contact information, home town, address, educational background (e.g., schools, majors, etc.), current job title, job description, industry, employment history, skills, professional organizations, memberships to other social networks, customers, past business relationships, and seller preferences; and inferred member information based on the member's activity, social graph data, overall trend data for the social networking system 120, and so on;
   skill data 132 including data representing a member's stated or inferred skills;
   job listing data 134 including data describing one or more job opportunities including a source organization, one or more required skills, a job title, a location, a team name, compensation amount, a list of responsibilities and requirements, and so on; and
   social graph data 138 including data that represents members of the social networking system 120 and the social connections between them.

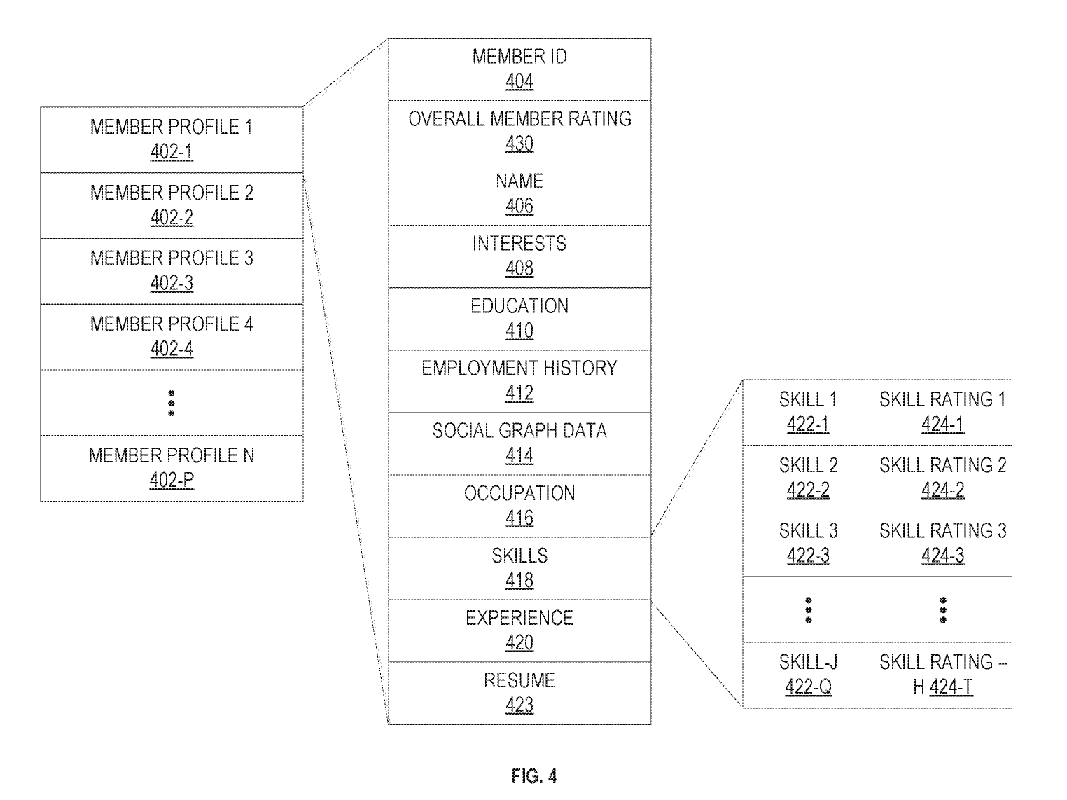

FIG. 4 depicts a block diagram of an exemplary data structure for the member profile data 130 for storing member profiles in accordance with some example embodiments. In accordance with some example embodiments, the member profile data 130 includes a plurality of member profiles 402-1 to 402-P, each of which corresponds to a member of the social networking system (FIG. 1, 120).

In some example embodiments, a respective member profile 402 stores a unique member ID 404 for the member profile 402, the overall member rating 430 for the member, a name 406 for the member (e.g., the member's legal name), member interests 408, member education history 410 (e.g., the high school and universities the member attended and the subjects studied), employment history 412 (e.g., member's past and present work history with job titles), social graph data 414 (e.g., a listing of the member's relationships as tracked by the social network system (FIG. 1, 120)), occupation 416, skills 418, experience 420 (for listing experiences that do not fit under other categories like community service or serving on the board of a professional organization), and a detailed member resume 423.

In some example embodiments, a member profile 402 includes a list of skills (422-1 to 422-Q) and associated skill ratings (424-1 to 424-T). Each skill 422 represents a skill or ability that the member associated with the member profile 402 has. For example, a computer programmer might list FORTRAN as a skill. In addition, each skill has an associated skill rating 424. In some example embodiments, a skill rating represents the social networking system's (FIG. 1, 120) estimation of the member's proficiency in a skill. For example, the skill rating could he a number from 1 to 100 wherein 100 is the highest skill and 1 is the lowest. Thus a member who had. AutoCAD with a skill rating of 25 would be less proficient using AutoCAD than a member with a skill rating of 78. In some example embodiments an overall member rating is generated based on feedback from other members (e.g., recommendations or endorsements) and based on the information stored in the member profile 402 associated with the member.

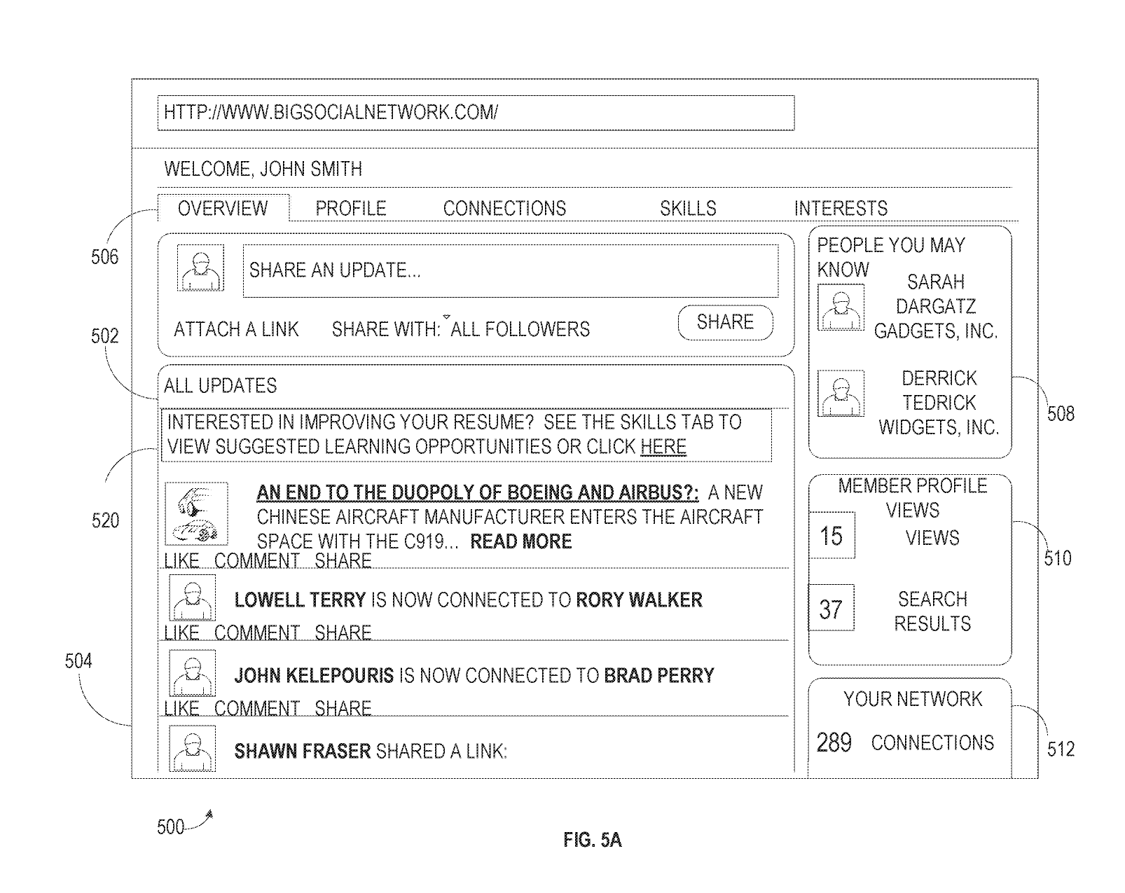

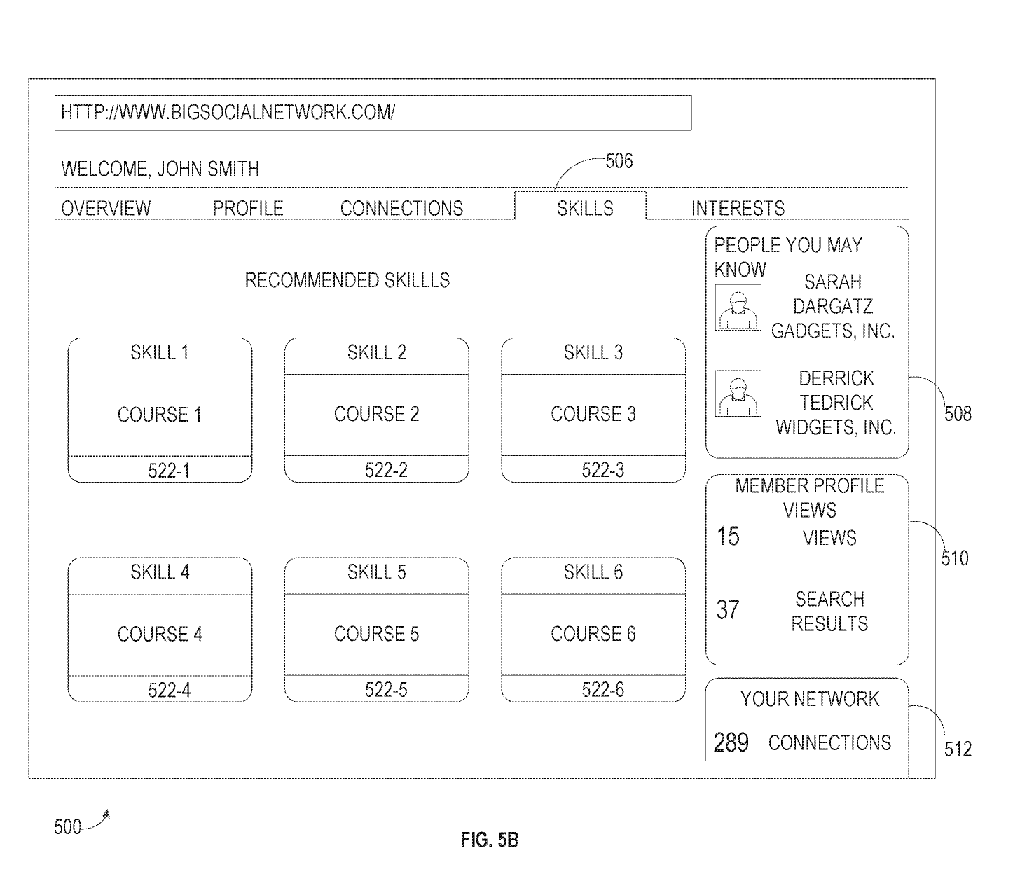

FIG. 5A is a user interface diagram illustrating an example of a user interface 500 or web page that incorporates a content feed for a member of a social networking system (e.g., system 120 in FIG. 1) In the example user interface 500 of FIG. 5A, the displayed user interface represents a web page 504 for a member of the social networking service with the name John Smith. In this example, not only does the content stream 502 present content selected specifically for John Smith, the content stream 502 is itself presented within a member interface or web page that is personalized for John Smith.

In some example embodiments, the user interface 500 also includes a notification that one or more skills have been recommended for the member. In this example, the notification 520 includes a link to the “Skills” tab that allows a member to immediately view one or more recommended skills.

The user interface 500 also includes information in side sections of the interface 500 including a contact recommendation section 508, profile viewership statistic section 510, and a social graph statistic section 512.

FIG. 5B is a user interface diagram illustrating an example of a user interface 500 or web page that displays a plurality of skill recommendations in response to selection of the skills tab and represents a continuation from FIG. 5A.

FIG. 5B displays a plurality of recommended skills (522-1 to 522-6) in the skills tab 506 of the user interface. Each skill includes a skill name and information of a course that teaches or allows a student to learn the skill (e.g., a short description of the course and a link to the place where a member can enroll or experience the course.)

The user interface 500 also includes information in side sections of the interface 500 including a contact recommendation section 508, profile viewership statistic section 510, and a social graph statistic section 512.

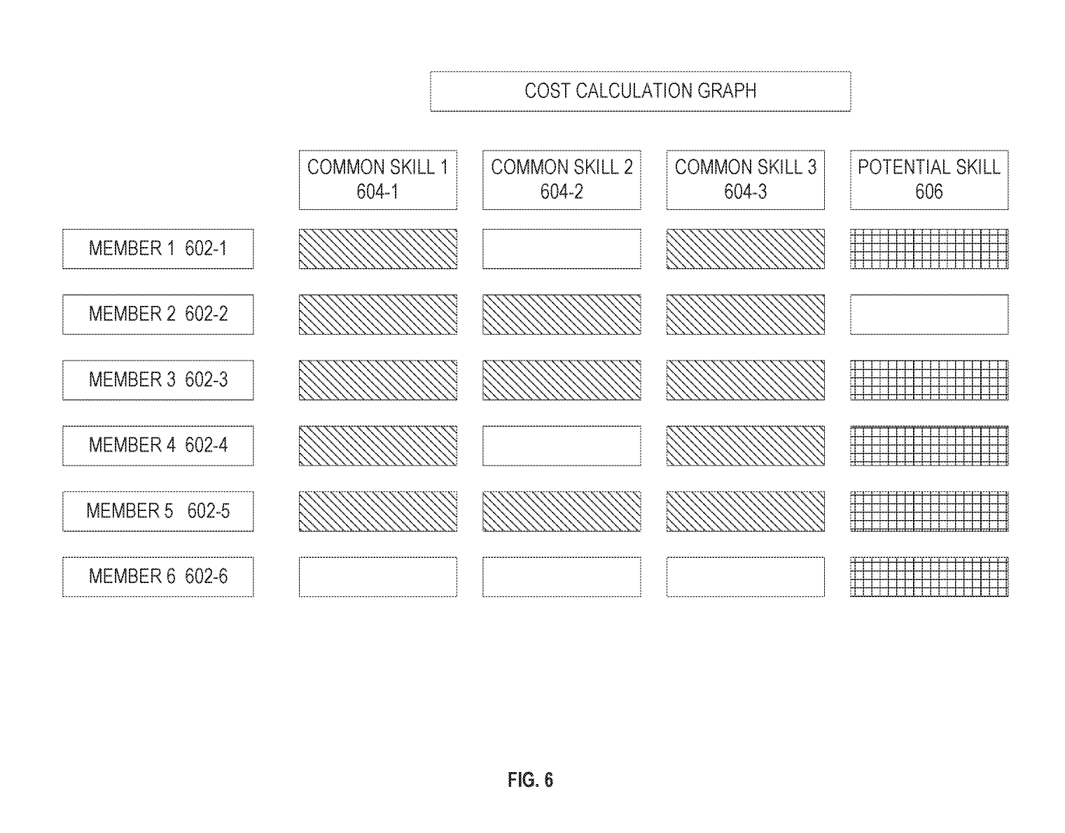

FIG. 6 is a graph representing a plurality of members and the skills that each of them possess.

In this graph, a plurality of members (Members 1 to 6, 602-1 to 602-6) are listed in each row. In some example embodiments, the members (Member 1 through Member 6 are included in the same member grouping. The graph also includes four skills. Three of the skills are commons skills (604-1 to 604-3) that are also held by the candidate member (not pictured). Thus, the plurality of members (602-1 to 602-6) are members that share at least one of the common skills (604-1 to 604-3) with the candidate member. For each member the chart includes an indication whether the member has that skill or not (blank spaces indicate the member does not have the skill, where spaces filled with lines indicate that the member has the skill.). For example, Member 1 has common skill 1 604-1, common skill 3 604-3, and potential skill 606.

In some example embodiments, the potential skill is the skill that is being considered for recommendation to the candidate member. Each member has an indication whether the member has the potential skill 606. The social networking system (e.g., system 120 in FIG. 1) uses this graph information to estimate the cost of the potential skill. Thus cost can be calculated by determining the number of members with any common skill with the candidate member. In this example, Member 1 602-1, Member 2 602-2, Member 3 602-3, Member 4 602-4, and Member 5 602-5 all have at least one common skill (whereas Member 6 602-6 does not).

The social networking system (e.g., system 120 in FIG. 1) then determines the number of members from this group who do not have the potential skill 606. In this example, there is only one member (Member 2, 602-2) that has at least one common skill but does not already have the potential skill 606.

The social networking system (e.g., system 120 in FIG. 1) then calculates the ratio of members who have at least one common skill but do not have the potential skill 606 to members who have any of the common skills. Thus the ratio in this example is 1/5.

This calculation is represented by the formula:

$$C ( p s \vert cs ) = \frac{number of members with at least one cs but without the p s}{number of members with at least one cs}$$

wherein C represents the cost, ps represents the potential skill, and cs represents the common skills.

The social networking system (e.g., system 120 in FIG. 1) is able to estimate how rare it is for a member with a certain set of skills to gain a particular potential skill by determining how often members with skill sets similar to the candidate member's skill set lack that skill. If that particular potential skill is rare among similar members (e.g., the ratio is near 1) the social networking system (e.g., system 120 in FIG. 1) determines that the skill has a high cost to obtain.,

However if the particular potential skill is common among members with skill sets similar to the candidate member (e.g., the above ratio is close to 0), the social networking system (e.g., system 120 in FIG. 1) determines that the skill has relatively low cost.

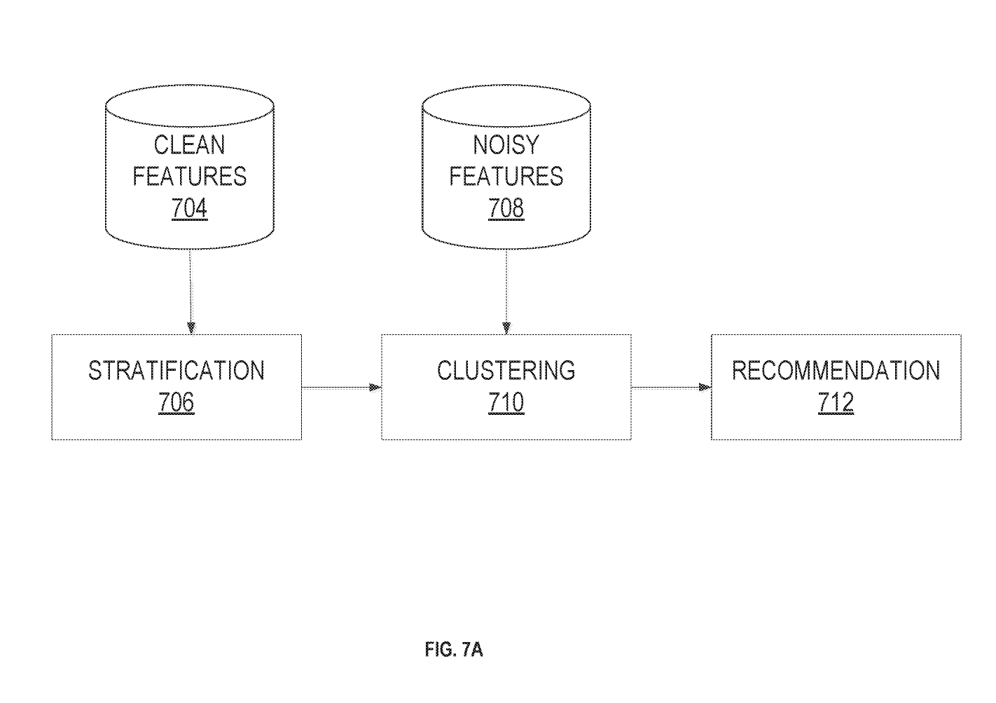

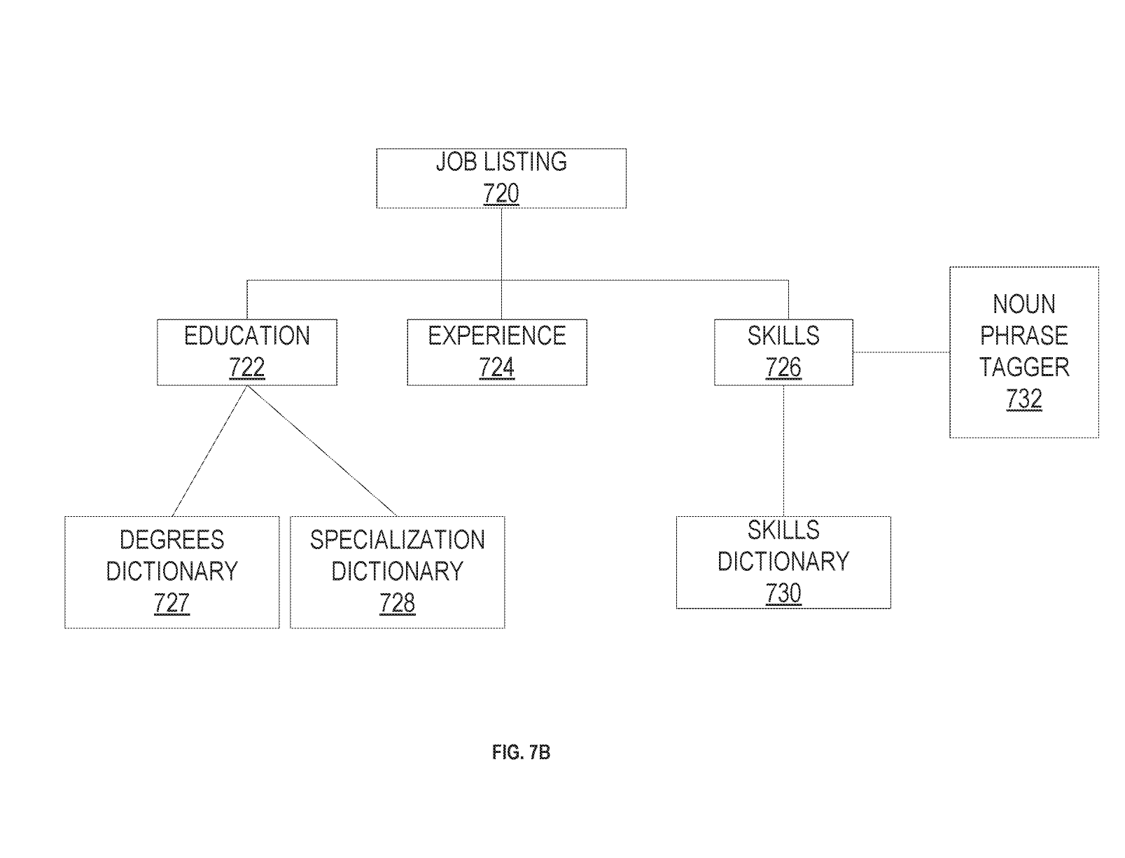

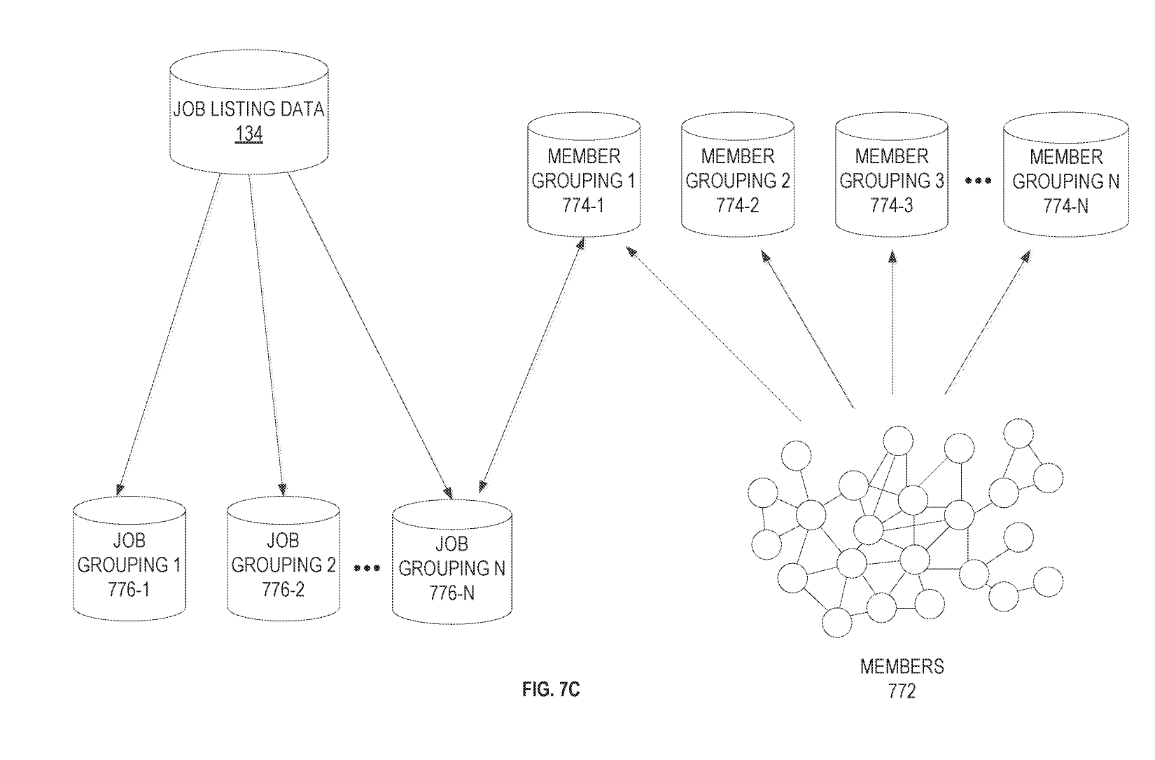

FIG. 7A is a block diagram illustrating a method, in accordance with some example embodiments, for using stratification and clustering to provide recommendations. Each of the operations shown in FIG. 7A may correspond to instructions stored in a computer memory (e.g., memory 306) or a computer-readable storage medium. In some example embodiments, the method 700 described in FIG. 7A is performed by the social networking system (e.g., system 120 in FIG. 1).

In some example embodiments, the method is performed at a social networking system (e.g., system 120 in FIG. 1) including one or more processors and memory (e.g., memory 306 in FIG. 3) storing one or more programs for execution by the one or more processors.

The social networking system (e.g., system 120 in FIG. 1) accesses data associated with members of the system and job listings. In some example embodiments, some of data can be cleanly used (e.g., it is easy to parse and sort into clear and certain categories), while other data is less clean to be used (e.g., the data that has ambiguity or cannot definitely sorted into groups).

In some example embodiments, the social networking system (e.g., system 120 in FIG. 1) processes clean features 704 first through a process of stratification 706. In some example embodiments, clean features include member location, member work experience, education, industry, skills, and so on. These data fields can be provided by the member and are thus easily extracted from member data or derived from that member data.

The social networking system (e.g., system 120 in FIG. 1) then conducts a process of stratification 706 on the clean features 704. Stratification involves separating members into different categories based on easily determined differences. For example, a group of members can be stratified based on the city and industry in which they work.

This same process can be performed for job opportunities. Each job opportunity (e.g., a job listing) has a clear city in which it is located and an industry in which is located. The members and jobs can be matched based on being in the same city and industry.

The social networking system (e.g., system 120 in FIG. 1) can then cluster the members and/or jobs. Clustering (710) is performed based on noisy features (e.g., data where the specific categories can be unclear). In some example embodiments, clustering is performed by one or more clustering algorithms including, but not limited to, static blocking, parametric Bayesian clustering, non-parametric Bayesian clustering, and non-parametric Bayesian sparse mixed membership model.

Once all jobs and members have been stratified and/or clustered, the social networking system (e.g., system 120 in FIG. 1) then generates recommendations for members based on the results of the clustering and stratification modules.

In some example embodiments, each skill can be ranked on a variety of different measures. In some example embodiments, once members are clustered, the social networking system (e.g., the social networking system 120 in FIG. 1) can generate member-derived skill scores.

For example, the social networking system (e.g., the social networking system 120 in FIG. 1) groups four members into a cluster. The social networking system (e.g., the social networking system 120 in FIG. 1) then determines the percentage of members in the cluster that includes a given skill. Thus, if three of the four members in the cluster have skill A, then the member-derived skill score is ¾ or 0.75. Similarly, skill B is a skill that only one of the four members has and thus has a member-derived skill score of ¼ or 0.25.

In some example embodiments, the member-derived skill score represents how common a given skill is in a particular group of members. In some example embodiments, skills that are very common in a group are a high priority to recommend to members of the group (or cluster) who do not have that skill In other example embodiments, very common skills are not determined to be significant factors in job eligibility and thus are less likely to be recommended.

In some example embodiments, the social networking system (e.g., the server system 120 in FIG. 1) also generates skill scores based on job listings. The job derived skill scores are generated by identifying a cluster of job listings and for each one, determining which skills are required by the job listing (e.g., by parsing the language of the job listing). Similar to the member-derived skill score, job derived skill scores are then generated based on the percentage of the jobs that require a given skill.

For example, in a cluster of twenty job listings, fourteen requires skill A. Skill A then has a 7/10 or 0.7 as the job-derived skill score. Skill B is only required by 8 of the twenty job listings, resulting in a lower job-derived skill score (⅖ or 0.4). In some example embodiments, job-derived skill scores can be thought of as reflecting demand for various skills.

In some example embodiments, the some job skills scores are temporally discounted such that jobs that are new are more heavily weighted in the job-derived skills scores and jobs that have been listed for a long time are discounted when job derived sill scores are calculated.

In some example embodiments, recommending a skill or skill group to a member includes determining both the member derived skill score and the job derived skill score to determine which skill brings the most benefit to the member. That skill is then recommended to the member.

FIG. 7B is a block diagram illustrating a system for generating structured data from unstructured job descriptions, in accordance with some example embodiments. Each of the components shown in FIG. 7B may correspond to instructions stored in a computer memory (e.g., memory 306) or a computer-readable storage medium. In some example embodiments, the method 700 described in FIG. 7A is performed by the social networking system (e.g., system 120 in FIG. I).

In some example embodiments, the social networking system (e.g., system 120 in FIG. 1) accesses a job listing 720. However, most job listings are unstructured, in that the data included in the job listing is not formatted to be accessible to the social networking system (e.g., system 120 in FIG. 1). For example, a job listing is as follows:
THE POSITION: As the Enterprise Architect, you'll be responsible for designing and implementing the overall application architecture and technical direction of WetFeet's core software as service product offering and leading and directing the daily activities of our software engineering team. You will work closely with the CEO and Product Manager to help the company expand its rapidly growing business providing best in class web based applications used by large and small corporations to manage their recruitment and talent management initiatives. We offer a fast paced, results-oriented environment where innovation, teamwork, and results are valued.
RESPONSIBILITIES: Lead the development team in the development and migration of an enterprise level software application currently written in ASP, VB and COM into a Microsoft certified NET solution Guide architecture, development and release of 2 3 major new functional modules per year Translate client and market business requirements into high performance functionality Define technical architecture to meet product performance, reliability and scalability goals Increase performance of key system metrics against current and future benchmarks Provide team leadership, mentorship, and growth opportunities for other technical team members Lead the development team by example and participate in the day to day development of new software modules and functionality Assist management team in assessing build vs buy decisions Research and assess third party software, development tools and emerging products and technologies Implement development standards and processes including: coding standards, technical specifications, code reviews Develop and maintain the technology roadmap and hit development release milestones Provide regular status reports of current projects to management team Reports to the CEO, and works closely with the Web Services Product Manager
QUALIFICATIONS: 7 years of application development experience on large scale, high transaction enterprise business solutions using Object Oriented Application Development techniques 2 years' experience developing within the Microsoft NET framework, and a minimum of 6 years of Microsoft N Tier development Proficiency with Microsoft technologies such as .Net, C#, ASP, SQL Server client development environments such as XML, XML Schema processing technologies including XSLT and web service technologies including SOAP, WSDL, and XML Proven experience in business analysis, data modeling, logical and physical database design BS or MS degree in Computer Science, Engineering, or related field, or equivalent work experience Strong knowledge of UML and small team development methodologies Experience in creating technical architectures capable of supporting high volume web hosted solutions Experience developing web services solutions for complex business requirements including but not limited to Outlook integration, HMS integration, search, workflow, archiving, and reporting analytics Proven experience managing software development teams and delivering successful product releases Demonstrate an understanding of customer requirements and their business needs Excellent customer service attitude and work ethic Must be self-motivated and capable of directing the work of others Demonstrated strong capabilities in written and verbal communication and presenting at all levels of the organization Must have excellent problems solving, team building skills Technical certifications such as Microsoft Certified Solution Developers MCSDs desired, but not required.
COMPENSATION: The compensation package will include a competitive salary commensurate with experience, stock options, 401k plan and health insurance benefits.

As can be seen, the job listings include a large amount of data without a structure that is complicated for a social networking system (e.g., the social networking system 120 in FIG. 1) to access because it is written in a natural language format, not in a format that is immediately accessible to the social networking system (e.g., system 120 in FIG. 1). The social networking system (e.g., the social networking system 120 in FIG. 1) then must parse the job listing 720 to use the job listing 720 as useful data in the social networking system (e.g., the social networking system 120 in FIG. 1).

In this example, the social networking system (e.g., the social networking system 120 in FIG. 1) breaks the job listing into educational requirements 722, experience requirements 724, and skill requirements. In some example embodiments, the unstructured job listing data is parsed using ontologies and natural language processing techniques.

In some example embodiments, the education requirements are extracted using a degrees dictionary 727. In some example embodiments, the degrees dictionary 727 includes a list of educational degrees. Each list of educational degree includes a list of alternate degree names (e.g., using different names for the same or very similar degrees), degrees that cover the same or similar score, and one or more words or names associated with each degree,

For example, the social networking system (e.g., the social networking system 120 in FIG. 1) identifies the words “BS or MS degree in Computer Science, Engineering, or related field” from the above job listing and uses the degrees dictionary to identify one or more matching degrees or degree categories. In some example embodiments, other words in the job listing, like “Net, C#, ASP, SQL” and “SOAP, WSDL, and XML” further help the social networking system (e.g., the social networking system 120 in FIG. 1) determines which degree or degree category is required.

In some example embodiments, the social networking system (e.g., the social networking system 120 in FIG. 1) also uses a specialization dictionary 726 to determine which, if any, specializations are required by the job listing. In some example embodiments, specializations are narrower groupings of member proficiencies that may be grouped differently than degrees some specializations can include members from different degrees) or may define sub-groups within degree groups.

Similar to the degrees dictionary 727, the specialization dictionary 728 includes a list of specializations and associated terms, such that words found in the job listing can be matched with specific specializations.

For example, the above job listing includes the words “Outlook integration, HRIS integration, search, workflow, archiving, and reporting analytics” and these words can be used to identify one or more specializations based on the specialization dictionary 728.

In some example embodiments, the education data 722 stores one or more identified degree or degree groups and one or more specialization or specialization groups. In some example embodiments, the social networking system (e.g., the social networking system 120 in FIG. 1) identifies multiple degrees and associates confidence levels with each difference degree.

In some example embodiments, the social networking system (e.g., the social networking system 120 in FIG. 1) uses natural language processing techniques to identify the experience requirements 724 for the job described in the job listing.

For example, the example job listing above states “7 years of application development experience on large scale, high transaction enterprise business solutions using Object Oriented Application Development techniques 2 years' experience developing within the Microsoft NET framework, and a minimum of 6 years of Microsoft N Tier development.” The social networking system (e.g., the social networking system 120 in FIG. 1) processes this information to determine a minimum number of years and a type of experience. This information can then be matched against stored member work history data.

In some example embodiments, the social networking system (e.g., the social networking system 120 in FIG. 1) also analyzes the job listing data to determine a list of skills 726 required or recommended for the job. In some example embodiments, a skills dictionary 730 includes a list of skills and, again, words and phrases associated with each skill.

The social networking system (e.g., the social networking system 120 in FIG. 1) parses the job description to identify particular words or phrases associated with particular skills. In some example embodiments, the particular words or phrases are identified by the noun phrase tagger 732.

The social networking system (e.g., the social networking system 120 in FIG. 1) then identifies the particular skills most likely to be required by the job listings (e.g., based on confidence scores)

In some example embodiments, once the social networking system (e.g., the social networking system 120 in FIG. 1) has parsed the job listing, a job listing record is created and stored at the social networking system (e.g., the social networking system 120 in FIG. 1), with organized data about the education requirements 722, experience requirements 724, and skill requirements 726 all stored in a format that is easy for the social networking system (e.g., the social networking system 120 in FIG. 1) to work with and interpret.

In some example embodiments, the social networking system (e.g., system 120 in FIG. 1) contains too many members, skills, and jobs to efficiently calculate all possible skill outcomes for all members at all times. In response, the social networking system (e.g., system 120 in FIG. 1) can create efficiency by grouping members and jobs into a plurality of buckets.

In some example embodiments, the members 772 are grouped into one of a plurality of buckets (member groupings 1-N as represented by 774-1 to 774-N) based on characteristics of the members 772, including but not limited to, the industry that the member currently works in, the member's employment role, the current title of the member, the current organization that the member works for, the latest academic degree or training certification the member has achieved, years of experience, field of academic degree, and the member's undergraduate school and/or program. In some example embodiments, the skills of a member can be used to group members. In other example embodiments, the social networking system (e.g., system 120 in FIG. 1) avoids grouping too closely by skills to avoid the situation in which all members of a given bucket have the same skill set, rendering it difficult to evaluate potential skills.

In some example embodiments, the size of the buckets is determined based on the needs of the system. In some example embodiments, larger buckets give more points of comparison for analysis but result in a less personalized recommendation for each member. In contrast, smaller buckets give more personalization but have fewer data points upon which to base their recommendations.

In some example embodiments, the social networking system (e.g., system 120 in FIG. 1) determines that a given bucket includes too many members. In response, the social networking system (e.g., system 120 in FIG. 1) adds an additional detail of the member profile to use in separating the members in a given bucket into still smaller buckets. For example, if a given bucket sorts members based on the industry in which they work and their undergraduate degree, the bucket for computer science majors in the software development industry may contain too many members. The social networking system (e.g., system 120 in FIG. 1) then sorts these members into still smaller buckets based on the school from which the members obtained their degree.

In some example embodiments, if the number of members in a given bucket is too few, the social networking system (e.g., system 120 in FIG. 1) can simply merge buckets by removing a particular variable as a sorting mechanism.

Similarly, the job listing data 134 are also grouped into two or more buckets (776-1 to 776-N). Each listing is put in a particular bucket based on, but not limited to, the title of the job, the industry the job is in, the experience required, the textual description of the job, recommended or required skills, and compensation.

In some example embodiments, the social networking system (e.g., system 120 in FIG. 1) groups members into buckets with a goal of having a specific level of skill diversity. In this way, the skill sets of the various members are distinct enough that potential new skills can be analyzed for each member. However, the members must also have sufficient skill overlap that comparisons between members have meaning.

In some example embodiments, the social networking system (e.g., system 120 in FIG. 1) measures the multiset Jaccard similarity (MJS) to analyze the skill diversity in a given bucket. MJS is a ratio of the intersection of skill data sets for each member (e.g., the number of skills that are held by every member of the group) to the union of the skill data sets for each member (e.g., the number of skills that at least one member of the bucket has). In some example embodiments, the social networking system (e.g., system 120 in FIG. 1) can also measure the multiset Jaccard cost (MJC), which is the MJS subtracted from 1. Using the MJS and the MJC, the social networking system (e.g., system 120 in FIG. 1) can arrange buckets that have an optimal or near optimal skill set diversity.

In some example embodiments, once both the members and the jobs are grouped into buckets, the social networking system (e.g., system 120 in FIG. 1) can determine whether the members of a given bucket have a high propensity to be accepted for the jobs in the bucket. In this way, the social networking system (e.g., system 120 in FIG. 1) can determine how a given bucket or member job propensity is altered by adding one or more potential skills.

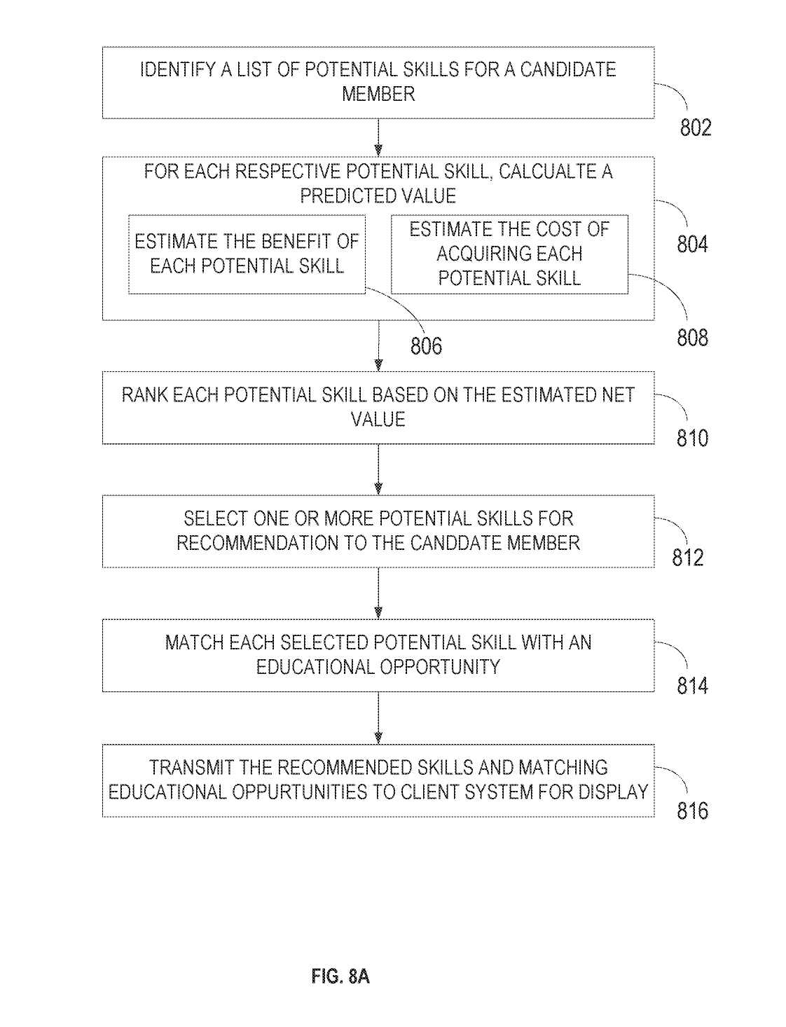

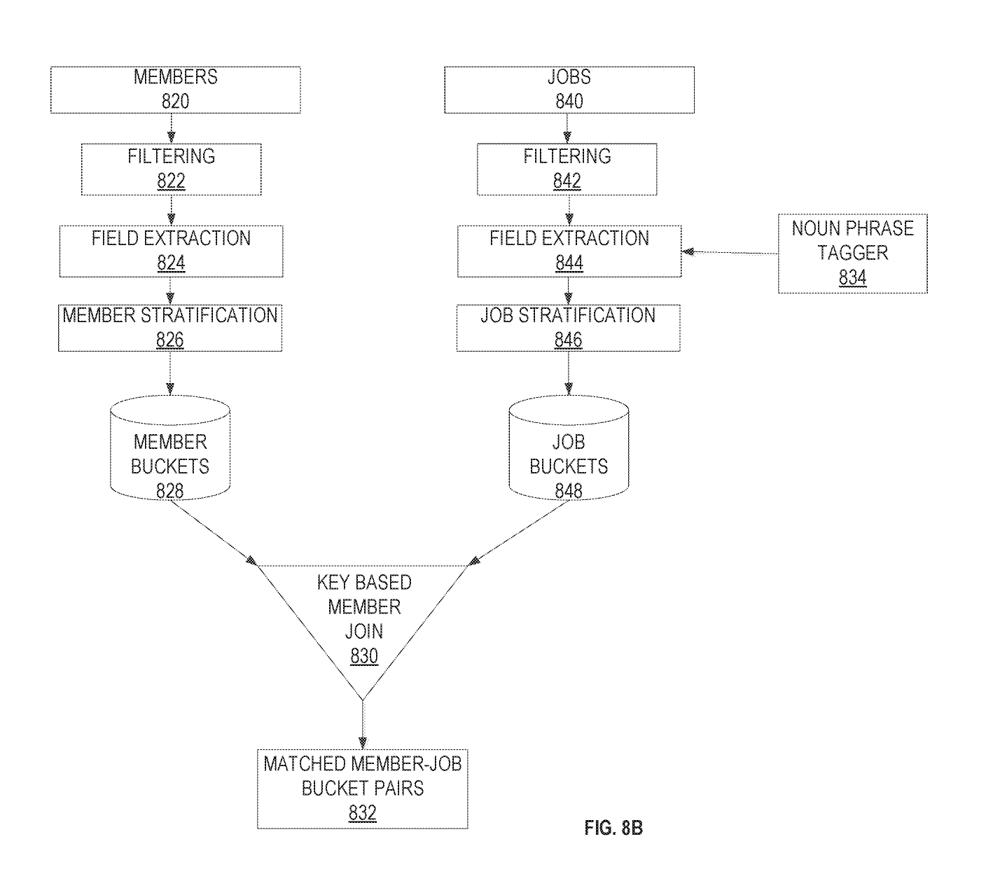

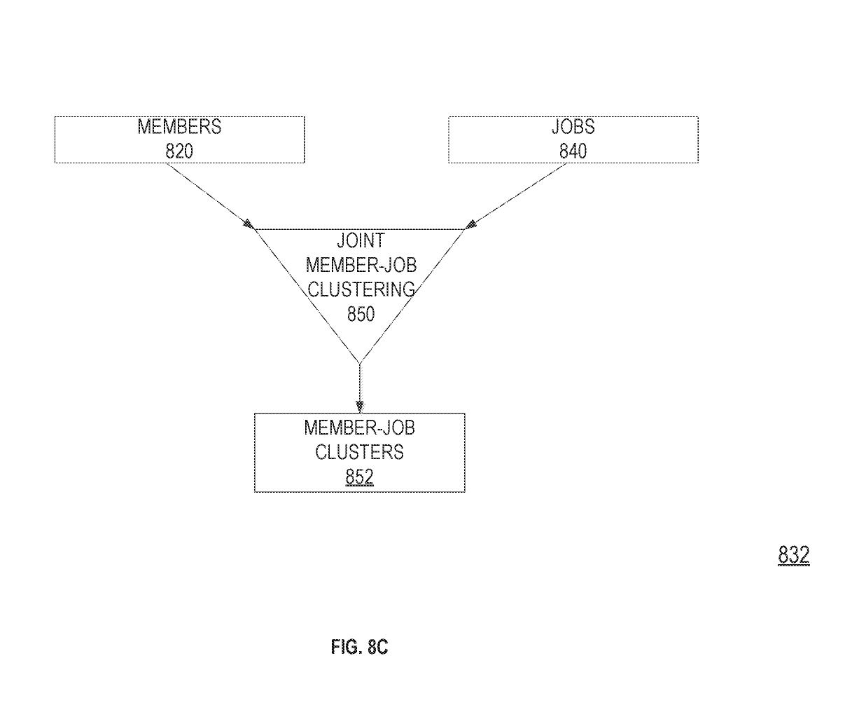

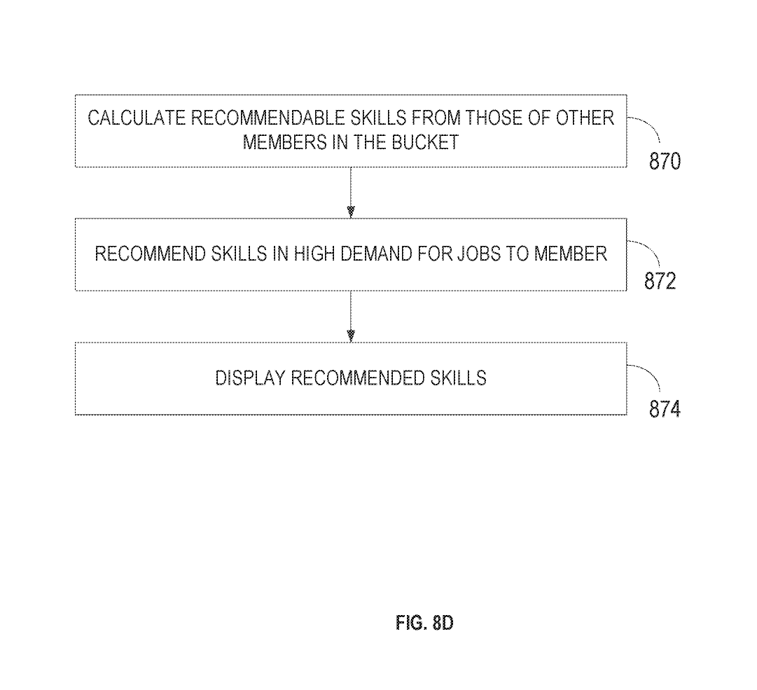

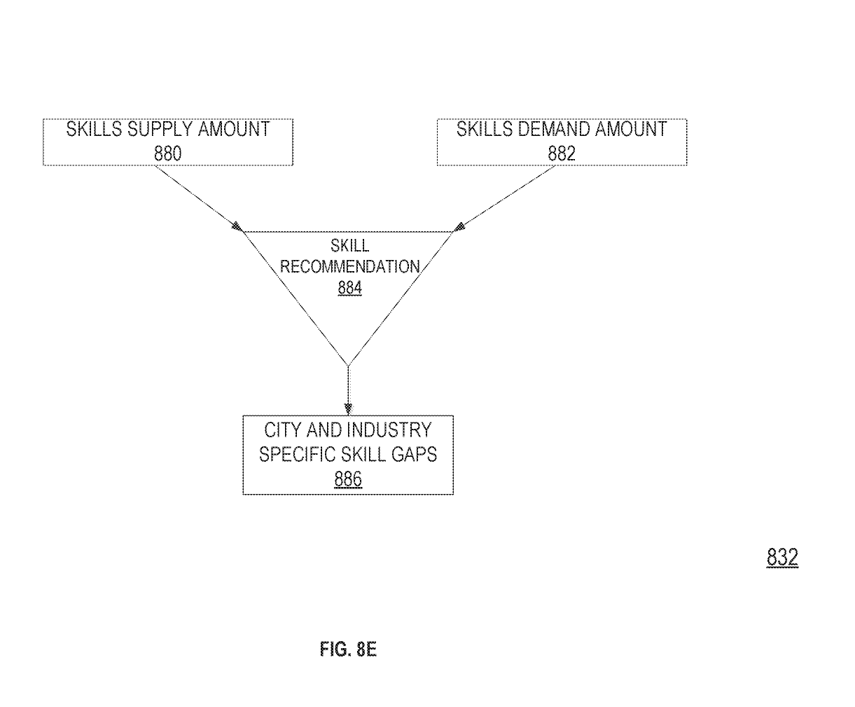

FIG. 8A is a flow diagram illustrating a method, in accordance with some example embodiments, for personalizing skill recommendations to members of a social networking system. Each of the operations shown in FIG. 8A may correspond to instructions stored in a computer memory or computer-readable storage medium. In some embodiments, the method described in FIG. 8A is performed by the social networking system (e.g., system 120 in FIG. 1). However, the method described can also be performed by any other suitable configuration of electronic hardware.

In some embodiments the method is performed at a social networking system (e.g., system 120 in FIG. 1) including one or more processors and memory storing one or more programs for execution by the one or more processors.

The social networking system (e.g., system 120 in FIG. 1) identifies (802) a list of potential skills for a candidate member of the social networking system (e.g., system 120 in FIG. 1). In some example embodiments, the list is determined based on the skill sets of members with similar jobs or in a similar industry as the candidate member.

For each respective potential skill, the social networking system (e.g., system 120 in FIG. 1) calculates (804) a predicted net value to the candidate member if he or she gained the respective potential skill.

Calculating a predicted value includes estimating (806) the benefit of each potential skill. In some example embodiments, estimating the benefit is accomplished by first establishing a baseline by determining the member's current compensation and the number of jobs for which the member is a good candidate. The social networking system (e.g., system 120 in FIG. 1) then determines, for each potential skill, the increase in the number of jobs for which the candidate is suited for. The benefit for each potential skill is then determined based on the difference between the base number of job opportunities and the number of job opportunities available after the potential skill is added.

The social networking system (e.g., system 120 in FIG. 1) then estimates (808) a cost of acquiring each potential skill. In some example embodiments, the cost can be measured directly by determining the amount of money needed to attend relevant educational opportunities to gain the skill (e.g., take courses, training seminars, and so on) and the amount of time that each educational opportunity will take. In some example embodiments, the cost can only be indirectly estimated by determining how common the skill is within a group of similar peer members.

For example, the social networking system (e.g., system 120 in FIG. 1) determines that a particular potential skill is very common among members with otherwise similar skill set, the social networking system (e.g., system 120 in FIG. 1) estimates that the cost of the skill is relatively low. If Member A is a web designer with CSS skills and HTML, skills, and 90 percent of similar members also have skills in JavaScript, the social networking system (e.g., system 120 in FIG. 1) estimates that it is relatively easy for Member A to learn basic JavaScript skills. Similarly, if a skill is relatively rare in a member's peer group, the social networking system (e.g., system 120 in FIG. 1) estimates that it is relatively difficult to learn for that member.

In some example embodiments, the net value is then determined by subtracting the estimated cost to learning the skill from the estimated benefit from learning the skill.

In some example embodiments, the social networking system (e.g., system 120 in FIG. 1) ranks (810) each potential skill based on the determined net value to learning that skill. Thus, potential skills with high net value are ranked above potential skills with low net value.

In some example embodiments, the social networking system (e.g., system 120 in FIG. 1) selects (812) one or more potential skills for recommendation to the candidate member. For each selected skill, the social networking system (e.g., system 120 in FIG. 1) determines a matching educational opportunity. Such matches are based on information about the skills provided by the educational opportunity, the time needed, availability, language of presentation, and so on.

In some example embodiments, the social networking system (e.g., system 120 in FIG. 1) then transmits (816) the recommended skills and matching educational opportunities to the client system (e.g., the client system 102 in FIG. 1) for display to the candidate member.

FIG. 8B is a flow diagram illustrating a method, in accordance with some example embodiments, for personalizing skill recommendations to members of a social networking system. Each of the operations shown in FIG. 8B may correspond to instructions stored in a computer memory or computer-readable storage medium. In some embodiments, the method described in FIG. 8B is performed by the social networking system (e.g., system 120 in FIG. 1). However, the method described can also be performed by any other suitable configuration of electronic hardware.

In some embodiments the method performed at a social networking system (e.g., system 120 in FIG. 1) including one or more processors and memory storing one or more programs for execution by the one or more processors.

In some example embodiments, the social networking system (e.g., system 120 in FIG. 1) has data for a plurality of members 820.

In some example embodiments, the social networking system (e.g., system 120 in FIG. 1) then filters (822) this data to identify members for which it wishes to determine one or more skill recommendations. In some example embodiments, the members are filtered based on the express intention of the members, such that members who expressly request skill recommendations receive them or, conversely, members who expressly request to not receive skill recommendations are filtered out.

In other example embodiments, members are filtered based on the demographic or activity information about the members (e.g., members that look at job listings are more likely to desire a new skill and so on). Thus, any member whose estimated interest in a new skill (e.g., based on information in the member profile) is above a threshold hold is included in a list of members for whom new skill recommendations are determined, while those members who have an estimated interest below the threshold are filtered out of the list.

in some example embodiments, the social networking system (e.g., system 120 in FIG. 1) extracts (824) relevant data fields from the member's profile including location, education, experience, skills, industrial field, job title, work history, and so on.

Use the extracted filled information, the members are stratified into one or more member buckets 828. In some example embodiments, the members are stratified based on one or more key data fields. For example, all the members in the social networking system (e.g., system 120 in FIG. 1) could be grouped into one or more buckets based on a key pair of the city the member is located in and the industry in which the members works or hopes to work in.

Thus, the member buckets 828, include a plurality of members that have been sorted based on one or more key fields of information in their member profiles and thus have overlapping areas of interest.

In some example embodiments, the social networking system (e.g., system 120 in FIG. 1) also identifies a plurality of jobs 840. In some example embodiments, the plurality of jobs include a plurality of job listings sent to or retrieved by the social networking system (e.g., system 120 in FIG. 1).

In some example embodiments, the jobs are filtered (842). In some example embodiments, the filtering is based on the length of time that the job listing has been posted (e.g., if the job listing has been posted for more than six months, the social networking system (e.g., system 120 in FIG. 1) starts filtering it out of this analysis).

In some example embodiments, the social networking system (e.g., system 120 in FIG. 1) uses natural language processing techniques to extract data fields (844) from the text of each job listing. In some example embodiments, because the job listings are relatively unstructured data, the social networking system (e.g., system 120 in FIG. 1) uses a noun phrase tagger (834) to identify which words in the job listings are the most important to extract.

In some example embodiments, once the job data in the job listings has been extracted into organized data fields, the job listings can be stratified (846) based one or more data fields.

In some example embodiments, the stratified job listings are placed into one or more job buckets 848. In some example embodiments, each job bucket includes a list of jobs that have one or more common data fields.

In some example embodiments, the data fields used to stratify the job listings into one or more job buckets 848 is the same, or at least associated with, the data fields used to stratify the members into one or more member buckets 828.

In some example embodiments, the social networking system (e.g., system 120 in FIG. 1) performs 830 a key based member join, where the member join is based on one or more key data fields that the member data and the job data have in common. In some example embodiments, the key data field is one of the one or more data fields used to stratify both the members and the jobs into their respective bucket.

For example, if both the member buckets 828 and the job buckets 848 are stratified based on the location and the industry of the members and the jobs, then the member buckets 828 and the job buckets 848 can be joined based on having matching locations and industries. Thus, matched member-job bucket pairs 832 include members in city A and industry B, and jobs from the same city and same industry.

FIG. 8C is a flow diagram illustrating a method, in accordance with some example embodiments, for clustering members and jobs in a particular matched member job bucket 832. As such, FIG. 8C continues the method of FIG. 8B. Each of the operations shown in FIG. 8C may correspond to instructions stored in a computer memory or computer-readable storage medium. In some embodiments, the method described in FIG. 8C is performed by the social networking system (e.g., system 120 in FIG. 1). However, the method described can also be performed by any other suitable configuration of electronic hardware.

In some example embodiments, the matched member-job bucket pairs include a plurality of member 820 and a plurality of jobs 840. As noted in FIG. 8B, all the members and jobs have been included in the matched member-job bucket pair 832 because they have one or more data fields in common. For example, the members 820 and the jobs 840 are all related to the same city and are in the same industrial field.

In some example embodiments, the social networking system (e.g., system 120 in FIG. 1) then clusters the members and jobs 850. In some example embodiments, the social networking system (e.g., system 120 in FIG. 1) uses one or more statistical techniques to cluster the members and jobs. For example, the social networking system (e.g., system 120 in FIG. 1) uses one of static blocking, Bayesian clustering, or non-parametric Bayesian clustering to cluster the members and jobs in the matched member-job bucket pairs 832.

In some example embodiments, the social networking system (e.g., system 120 in FIG. 1) then groups the members and jobs into the determined clusters. Once the members have been grouped into the smaller clusters, the social networking system (e.g., system 120 in FIG. 1) can use that information to generate personalized skill recommendations.

FIG. 8D is a flow diagram illustrating a method, in accordance with some example embodiments, for personalizing skill recommendations to members of a social networking system. Each of the operations shown in FIG. 8D may correspond to instructions stored in a computer memory or computer-readable storage medium. In some embodiments, the method described in FIG. 8D is performed by the social networking system (e.g., system 120 in FIG. 1). However, the method described can also be performed by any other suitable configuration of electronic hardware.

In some example embodiments, the social networking system (e.g., system 120 in FIG. 1) calculates (870) the recommendable skills from those of other members in a given member bucket. For example, for a given member, the social networking system (e.g., system 120 in FIG. 1) determines which skills are commonly held by other members of the member bucket.

In some example embodiments, the social networking system (e.g., system 120 in FIG. 1) first clusters the members in a given member bucket and then only uses the skills of members who have been clustered into the same member cluster. In this way, the skills are more closely related to the member for whom the skill recommendation is being generated.

In some example embodiments, the social networking system (e.g., system 120 in FIG. 1) then selects skills to recommend to the member based on determining the popularity of each skill. In some example embodiments, the popularity of a particular skill is estimated based on the number of job listings in a paired job listing bucket that require the particular skill.

For example, a skill that is required by 60 percent of job listings would be more popular than a skill that is required by 35 percent of job listings. Thus, once the list of skills is determined based on the skills of members in the bucket, each skills is then evaluated for popularity and the most popular skill is chosen.

In some example embodiments, the social networking system (e.g., system 120 in FIG. 1) then displays (874) the one or more recommended skills, in some example embodiments, the recommendations are displayed in response to a member specifically requesting a web page that includes the recommendation and then the skills are transmitted to the client system (e.g., the client system 102 in FIG. 1) for display as part of the requested page.

In other example embodiments, the member submits a general web page request (e.g., for an activity feed or member profile) without a specific request for skill recommendations. However the skill recommendations can be included in the responding web page in one or more sections of the web page not occupied by the requested content.

FIG. 8E is a flow diagram illustrating a method, in accordance with some example embodiments, for determining whether a skill gap exists for a particular cluster of members and jobs. Each of the operations shown in FIG. 8E may correspond to instructions stored in a computer memory or computer-readable storage medium. In some embodiments, the method described in FIG. 8E is performed by the social networking system (e.g., system 120 in FIG. 1). However, the method described can also be performed by any other suitable configuration of electronic hardware.

In some example embodiments, the social networking system (e.g., system 120 in FIG. 1) is able to calculate, for a particular cluster of related members and jobs, whether a skill gap exists for each skill and how great the skill gap is.

To do so, the social networking system (e.g., system 120 in FIG. 1) first determines the number of members in the cluster who have the skill 880. This information is stored in the member profiles of each member. In some example embodiments, the social networking system (e.g., system 120 in FIG. 1) considers members who have a particular skill as able to be supply for that skill. However, in other example embodiments, the social networking system (e.g., system 120 in FIG. 1) may determine which members are likely to change jobs and only count those members as supply.

In some example embodiments, the supply can be calculated by using a utility-based skill recommendation to make similarity-based recommendations using the traditional collaborative filtering approach, which recommends skills to a member that a plurality of members similar to him have already acquired. These recommendations capture the supply of skills by members in the labor market.

The social networking system (e.g., system 120 in FIG. 1) then determines the number of jobs 882 that require each skill. Each job listing that lists a particular skill represents demand for members with that skill. In some example embodiments, this is tracked based on skill recommendations on the basis of the number and quality of employment opportunities to capture the demand of skills by jobs in the labor market.

In some example embodiments, the social networking system (e.g., system 120 in FIG. 1) then compares, for each respective skill, the number of job listings that require that skill (e.g., the demand) to the number of members who have that skills (e.g., the supply). In accordance with a determination that more job listings require the respective skill than there are likely members to supply it, the social networking system (e.g., system 120 in FIG. 1) determines that there is a skill gap for that skill.

In other example embodiments, the social networking system (e.g., system 120 in FIG. 1) compares the number of times a skill was recommended in the utility-based recommendation system and the traditional similarity-based recommendation system at a certain level of granularity such as a city or industry, the social networking system can determine if the skill has a demand in the labor market that is not met by the supply from members at that level of granularity. On the basis of this comparison, the social networking system (e.g., system 120 in FIG. 1) can assign each skill a skill gap score at the particular level of granularity, and rank skills on this score to produce a ranked list of skills indicating the importance of a skill to public policy and educational institutions as evidenced by the demand of the skill in the employment opportunities and the lack of supply of the skill by members of the workforce.

In some example embodiments, a skill recommendation module 884 is more likely to recommend skills that have high skill gaps to members than skills with low skill gaps.

The social networking system (e.g., system 120 in FIG. 1) can also store a record of city and industry specific skill gaps 886. In some example embodiments, these records can be used to make additional recommendations, such as to educators who might want to know what classes/degrees are the most important for a given area.

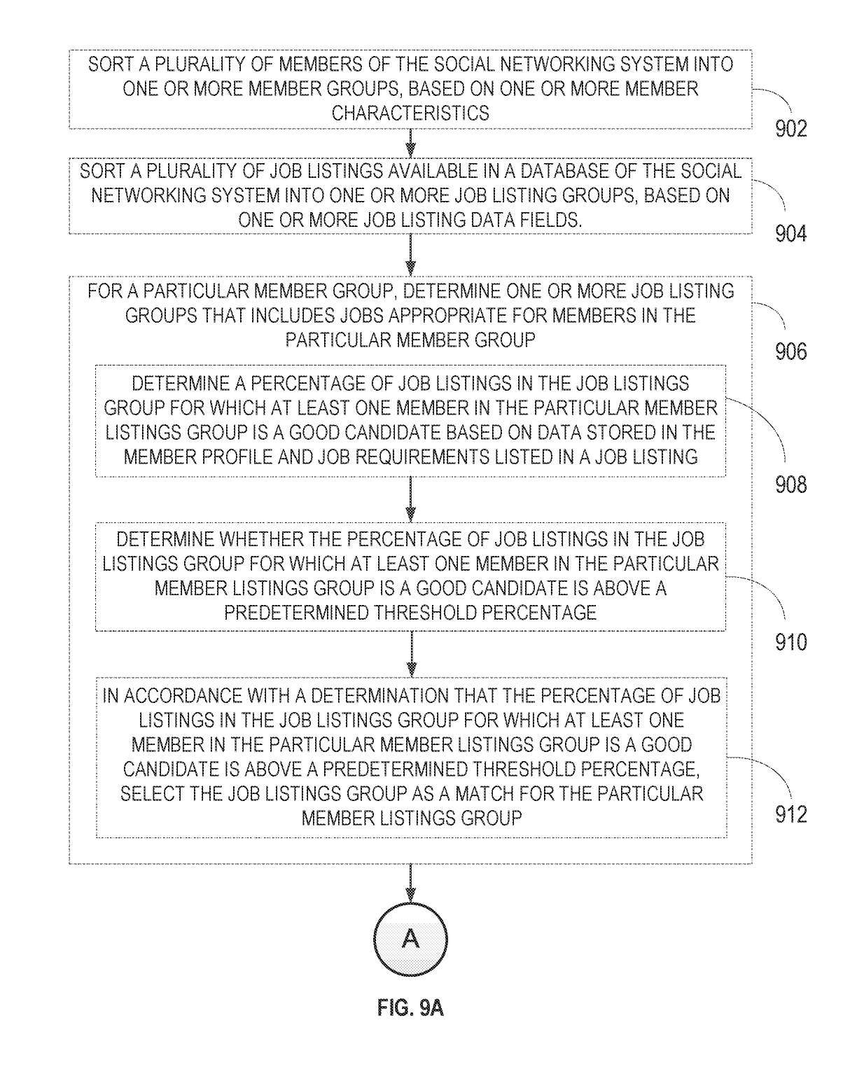

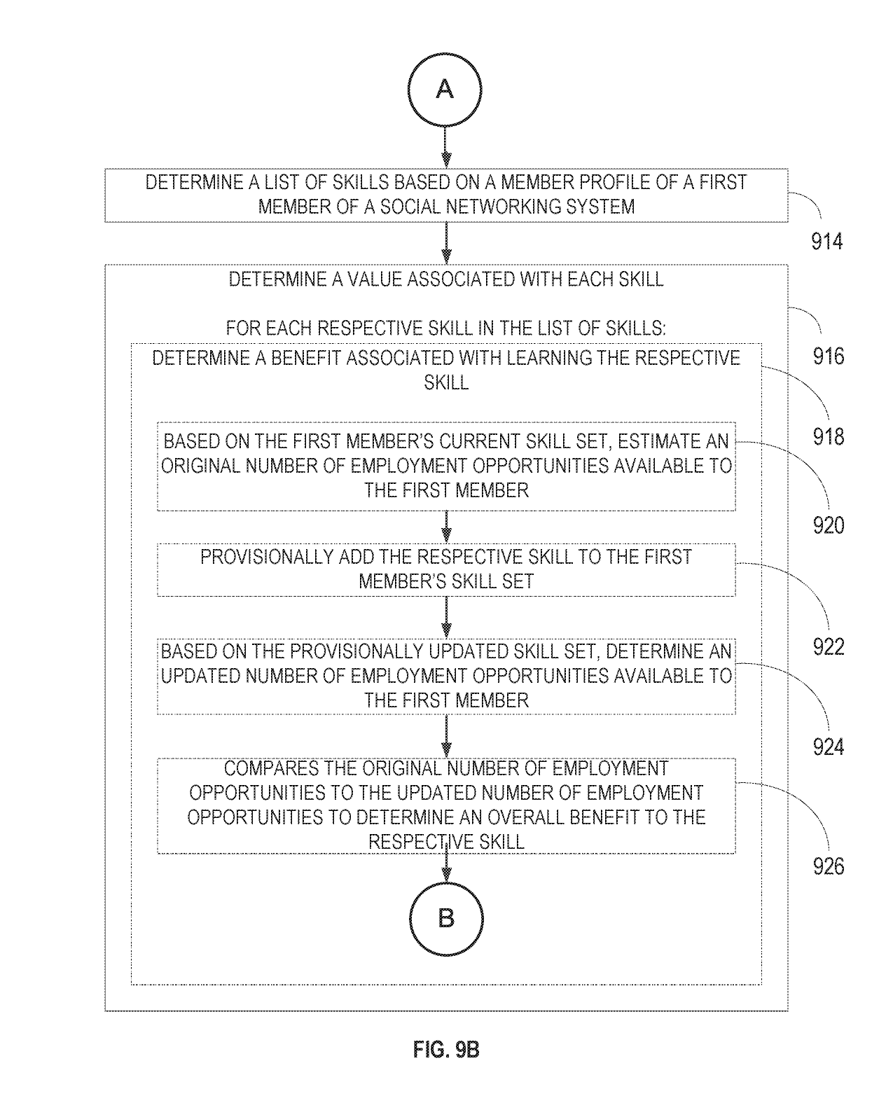

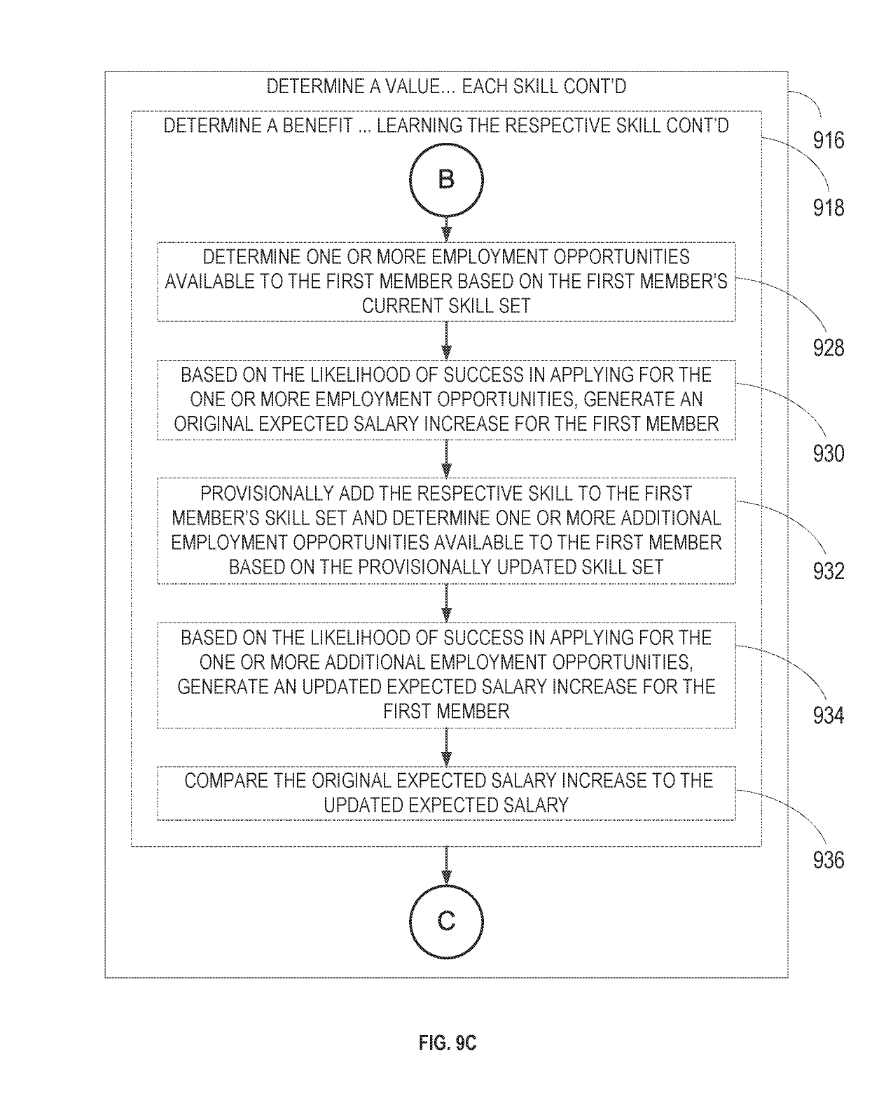

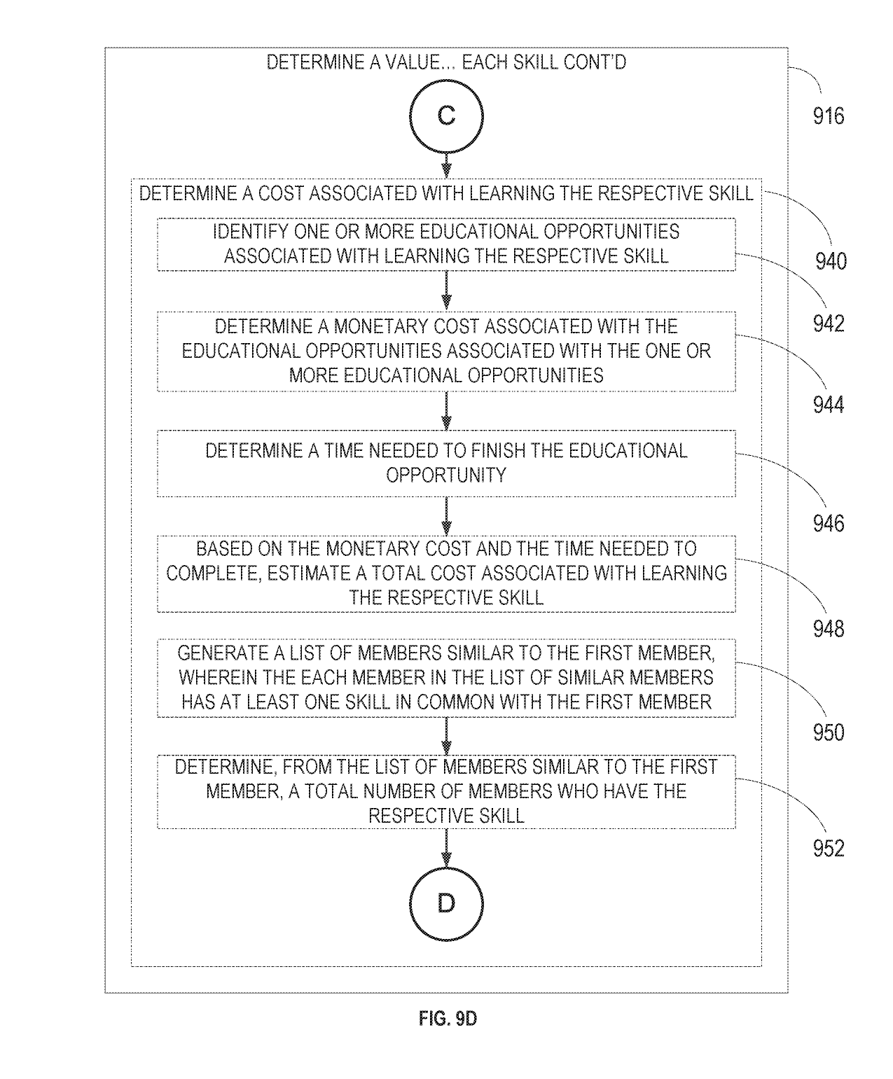

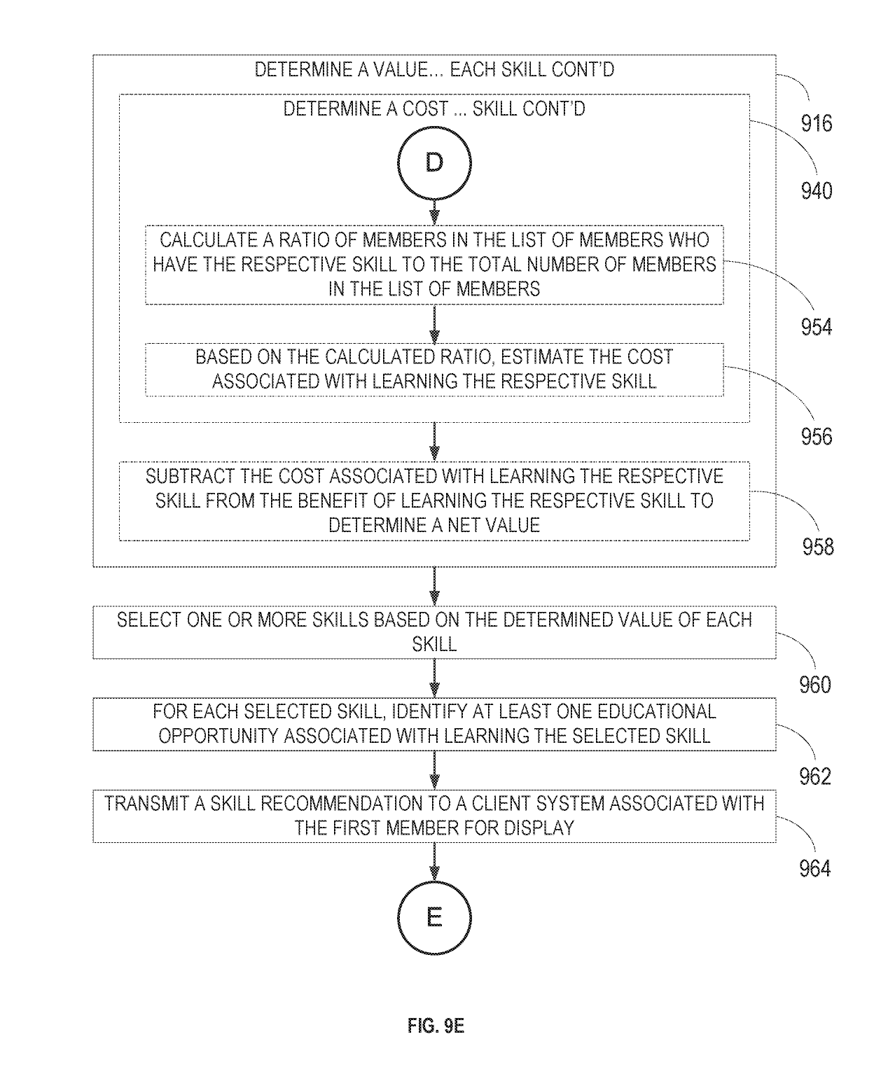

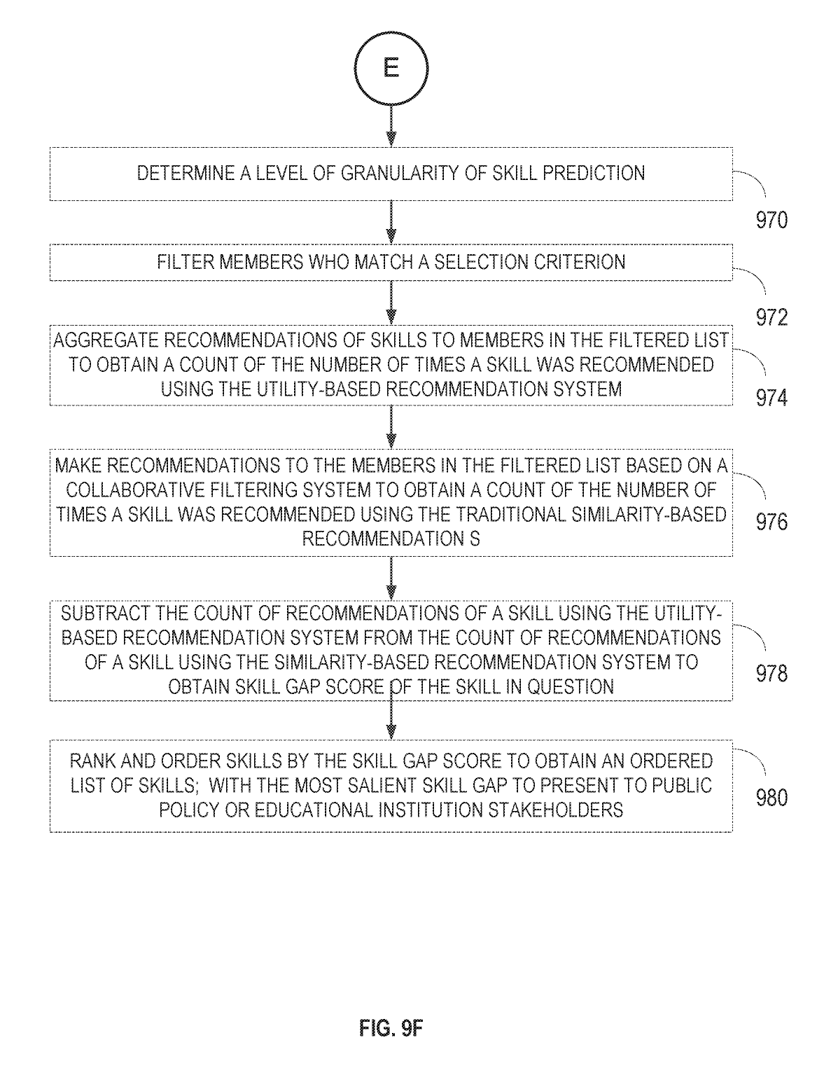

FIG. 9A is a flow diagram illustrating a method, in accordance with some example embodiments, for personalizing skill recommendations to members of a social networking system. Each of the operations shown in FIG. 9A may correspond to instructions stored in a computer memory or computer-readable storage medium. Optional operations are indicated by dashed lines (e.g., boxes with dashed-line borders). In some embodiments, the method described in FIG. 9A is performed by the social networking system (e.g., system 120 in FIG. 1). However, the method described can also be performed by any other suitable configuration of electronic hardware.

In some embodiments the method is performed at a social networking system (e.g., system 120 in FIG. 1) including one or more processors and memory storing one or more programs for execution by the one or inure processors.

In some example embodiments, the social networking system (e.g., system 120 in FIG. 1) identifies a group of members for which skills are to be recommended. In some example embodiments, this group is determined based on information included in the member profiles of the members. For example, some groupings could be based on one or more of members who have not added a new skill or changed jobs in two years, members with careers in a certain industry or technology, or members who live in a certain geographical region. In other example embodiments, the group of members is determined randomly. In yet other example embodiments, the group of members includes all members of the social networking system (e.g., system 120 in FIG. 1).

In some example embodiments, the social networking system (e.g., system 120 in FIG. 1) sorts (902) a plurality of members of the social networking system into one or more member groups or buckets, based on one or more member characteristics. For example, groups or buckets can be defined based on the industry in which the members work, the job titles of the members, the role of the members, the organization for which the members work, the level of experience a member has, the level of education the member has, the field in which the member has received their most recent degree, the educational institutions the members attended, and so on. In some example embodiments, the groups or buckets work best at a particular size (e.g., 100 members or 500 members) and the social networking system (e.g., system 120 in FIG. 1) adds or removes parameters for inclusion into buckets to reach an average bucket size in an acceptable range.

In some example embodiments, each bucket has a plurality of characteristics that define each bucket.

The social networking system (e.g., system 120 in FIG. 1) sorts (904) a plurality of job listings available in a database of the social networking system into one or more job listing groups, based on one or more job listing data fields. For example, the job listings are sorted into groups (or buckets) based on industry, title, experience required, the text of the job description, required skills, and so on. As with the member groups, the social networking system (e.g., system 120 in FIG. 1) determines an optimal size (e.g., 1000 job listings) and adds filter fields as necessary to achieve an average group or bucket size near the optimal size.

For a particular member group, the social networking system (e.g. system 120 in FIG. 1) determines (906) one or more job listing groups that includes jobs appropriate for members in the particular member group. Thus, the social networking system (e.g., system. 120 in FIG. 1) is able to restrict the total number of b listings and members that have to be compared against each other. In this way very large social networks can personalize skill recommendations efficiently, without having to compare every member against every job listing, which would be incredibly costly in terms of computer resources, time, and money.

In some example embodiments, determining whether a job listing group includes jobs appropriate for members in the particular member group further includes the social networking system (e.g., system 120 in FIG. 1) first determining (908) a percentage of job listings in the job listings group for which at least one member in the particular member listings group is a good candidate based on data stored in the member profile and job requirements listed in a job listing.

For example, the social networking system (e.g., system 120 in FIG. 1) determines whether a member in the particular member listing group is a good candidate for a job by determining the job requirements such as the required experience, the required skills, and the responsibilities of the job by analyzing the job listing. The social networking system (e.g., system 120 in FIG. 1) then determines whether the member skills, experience, education, and job history match all or most of the stated job requirements. If so, the social networking system (e.g., system 120 in FIG. 1) determines that that member is a good candidate for the job listing.

In some example embodiments, the social networking system (e.g., system 120 in FIG. 1) has stored data about past job listings and determined which members were hired for which job listings. Based on this stored data the social networking system (e.g., system 120 in FIG. 1) can train a classifier to statistically determine which members are good candidates. In some example embodiments, the social networking system (e.g., system 120 in FIG. 1) determines that one or more requirements in a job listing are more important than others and can weigh members based on an importance level for each requirement in the job listing.

In some example embodiments, the social networking system (e.g., system 120 in FIG. 1) determines (910) whether the percentage of job listings in the job listings group for which at least one member in the particular member listings group is a good candidate is above a predetermined threshold percentage. For example, the threshold percentage may be fifty percent. Thus, if fifty percent of the job listings in a job listing bucket have at least one member in a member bucket that is a good candidate, the job listing bucket's percentage will be above the threshold percentage.

In accordance with a determination that the percentage of job listings in the job listings group for which at least one member in the particular member listings group is a good candidate is above a predetermined threshold percentage, the social networking system (e.g., system 120 in FIG. 1) selects (912) the job listings group as a match for the particular member listings group. Thus, continuing the above example, the job listing bucket with an eighty percent matching rate with a particular member group will be determined to be a match for the particular member group.

FIG. 9B is a flow diagram illustrating a method, in accordance with some example embodiments, for personalizing skill recommendations to members of a social networking system. Each of the operations shown in FIG. 9B may correspond to instructions stored in a computer memory or computer-readable storage medium. Optional operations are indicated by dashed lines (e.g., boxes with dashed-line borders). In some embodiments, the method described in FIG. 9B is performed by the social networking system (e.g., system 120 in FIG. 1). However, the method described can also be performed by any other suitable configuration of electronic hardware.

In some embodiments the method is performed at a social networking system (e.g., system 120 in FIG. 1) including one or more processors and memory storing one or more programs for execution by the one or more processors.

In some example embodiments, the social networking system (e.g., system 120 in FIG. 1) determines (914) a list of skills based on a member profile of a first member of a social networking system (e.g., system 120 in FIG. 1). In some example embodiments, the social networking system (e.g., system 120 in FIG. 1) determines the list of skills, at least in part, based on the skills of the other members in the member group to which the first member was sorted. For example, the social networking system (e.g., system 120 in FIG. 1) determines skills that the first member does not have, but that are present in members that are sorted into the same bucket as the first member.

In some example embodiments, the social networking system (e.g., system 120 in FIG. 1) determines a value (916) associated with each skill. In some example embodiments, value for a particular skill is determined by the formula:

V(ns|m)=U(ns|m)−C(ns|m)

In this formula value (V) is based on the particular new skill (ns) and the member (m). The value is equal to the utility (U) or benefit minus the cost (C). Thus, for each respective skill in the list of skills, the social networking system (e.g., system 120 in FIG. 1) determines (918) a benefit associated with learning the respective skill and determines a cost associated with learning the respective skill.

In some example embodiments, determining a benefit associated with learning a respective skill further includes, based on the first member's current skill set, the social networking system (e.g., system 120 in FIG. 1) estimating (920) an original number of employment opportunities available to the first member.

In some example embodiments, the social networking system (e.g., system 120 in FIG. 1) provisionally adds (922) the respective skill to the first member's skill set. For example, the list of skills for Member A includes Skills E, T, M, and G. For the purposes of evaluating the effect of skill P on Member A's employment potential, the social networking system (e.g., system 120 in FIG. 1) temporarily adds skill P to the list of skills for additional analysis.

Based on the provisionally updated skill set, the social networking system (e.g., system 120 in FIG. 1) determines (924) an updated number of employment opportunities available to the first member. As discussed above, the social networking system (e.g., system 120 in FIG. 1) determines, for each job listing, whether the first member is a good candidate for that job based on the job requirements and the skills and experience of the first member.

In some example embodiments, the social networking system (e.g., system 120 in FIG. 1) compares (926) the original number of employment opportunities to the updated number of employment opportunities to determine an overall benefit to the respective skill.

In some example embodiments, the estimated number of employment opportunities is determined based on the job listings in one or more job listing groups associated with the member group into which the first member has been sorted.

In some example embodiments, the number of employment opportunities for which a given member is qualified in a given group of employment opportunities can be described as the member's job propensity for a given group of employment opportunities, such that a member with a higher job propensity score is a good candidate for more employment opportunities than a member with a lower job propensity score.

Thus, calculating the utility or benefit of a new skill can be measured by the following formula:

$$U ( skill = ns \vert member = m 1 ) = \frac{P 2 - P 1}{P 2}$$

Thus, the utility (U) of a new skill (ns) to a first member (m1) is determined based on the difference between the second propensity score (e.g., what proportion of the jobs is the first member a good candidate for including the new skill) and the first propensity score (e.g., what proportion of the jobs was the first member a good candidate for including only the member's current skill list). That difference is then divided by the second propensity score to normalize the result as a value between 0 and 1.

FIG. 9C is a flow diagram illustrating a method, in accordance with some example embodiments, for personalizing skill recommendations to members of a social networking system. Each of the operations shown in FIG. 9C may correspond to instructions stored in a computer memory or computer-readable storage medium. Optional operations are indicated by dashed lines (e.g., boxes with dashed-line borders). In some embodiments, the method described in FIG. 9C is performed by the social networking system (e.g., system 120 in FIG. 1). However, the method described can also be performed by any other suitable configuration of electronic hardware.

In some embodiments the method is performed at a social networking system (e.g., system 120 in FIG. 1) including one or more processors and memory storing one or more programs for execution by the one or more processors.

In some example embodiments, the social networking system (e.g., system 120 in FIG. 1) determines (928) one or more employment opportunities available to the first member based on the first member's current skill set. As noted above, this is accomplished by comparing the requirements for a set of jobs to the skills and experience of the first member. If the first member meets all or most of the important requirements, the first member is considered a good candidate for the job.

In some example embodiments, only job opportunities that represent an improved employment situation are considered. For example, a job listing must describe a job that represents an increase in pay, title, influence, and so on, to be included as a valid employment opportunity. In some example embodiments, job listings that do not represent an improved employment situation based on traditional metrics but enable other member preferences to be reflected can be considered. For example if a member has indicated interest in switching careers, a lesser paying job in the desired career field may be considered an improved job situation even if traditional measures of employment improvement (e.g., increases in pay, rank, and title) determine that it is not a better employment situation. Another example is a member indicating the member would prefer a job with better work/life balance, even if the total compensation is less.

Based on the likelihood of success in applying for the one or more employment opportunities, the social networking system (e.g., system 120 in FIG. 1) generates (930) an original expected salary increase for the first member. The likelihood of the first member successfully applying for a particular job (e.g., getting the job) is based on a number of factors including, but not limited to, the number of expected applicants, the skill set and experience of the other expected applicants relative to the skill set and experience of the first member, past hiring patterns of the hiring organization, the location of the job, and so on. The expected salary increase is a comparison between the first member's current salary and the listed job salary, discounted based on the likelihood that member will be offered the job (e.g., such that jobs for which an offer is very unlikely do not affect the expected salary increase very much) the social networking system (e.g., system 120 in FIG. 1) will not get offered the job.

The social networking system (e.g., system 120 in FIG. 1) then provisionally adds (932) the respective skill to the first member's skill set and determines one or more additional employment opportunities available to the first member based on the provisionally updated skill set. This process is very similar to the original salary calculation. The social networking system (e.g., system 120 in FIG. 1) determines which jobs first member would now be a good candidate for with the potential skill that is being considered.

Based on the likelihood of success in applying for the one or more additional employment opportunities, the social networking system (e.g., system 120 in FIG. 1) generates (934) an updated expected salary increase for the first member.

The social networking system (e.g., system 120 in FIG. 1) then compares (936) the original expected salary increase to the updated expected salary increase. The difference between the original expected salary increase and the updated expected salary increase is the benefit or utility of the potential skill.

FIG. 9D is a flow diagram illustrating a method, in accordance with some example embodiments, for personalizing skill recommendations to members of a social networking system. Each of the operations shown in FIG. 9D may correspond to instructions stored in a computer memory or computer-readable storage medium. Optional operations are indicated by dashed lines (e.g., boxes with dashed-line borders). In some embodiments, the method described in FIG. 9D is performed by the social networking system (e.g., system 120 in FIG. 1). However, the method described can also be performed by any other suitable configuration of electronic hardware.

In some embodiments the method is performed at a social networking system (e.g., system 120 in FIG. 1) including one or more processors and memory storing one or more programs for execution by the one or more processors.

In some example embodiments, the social networking system (e.g., system 120 in FIG. 1) determines (940) a cost associated with learning the respective skill. To determine the cost, the social networking system (e.g., system 120 in FIG. 1) identifies (942) one or more educational opportunities associated with learning the respective skill. In some example embodiments, the social networking system (e.g., system 120 in FIG. 1) has a plurality of sources to determine educational opportunities. For example, the social networking system (e.g., system 120 in FIG. 1) maintains a list of web-based courses, a list of university and college programs, training seminars, apprenticeships, internships, community college courses, and so on. Each of these educational opportunities is stored with a location and a cost (or estimated cost).

The social networking system (e.g., system 120 in FIG. 1) evaluates each educational opportunity that is associated with the correct skill to determine whether it is appropriate for the first member based on a number of factors including cost, location, availability, and so on. For example, for a member living in Mexico, a university course offered on a Canadian university campus to enrolled students is not very likely to be a valid education source for learning a particular skill. However, the social networking system (e.g., system 120 in FIG. 1) can determine whether there are any online courses or seminars or an educational institution more local to that member.

The social networking system (e.g., system 120 in FIG. 1) determines (944) a monetary cost associated with the educational opportunities. This cost includes tuition and any fees associated with the educational opportunities. In some example embodiments, a training program may provide a salary and this is also considered by the social networking system (e.g., system 120 in FIG. 1).

In some example embodiments, the social networking system (e.g., system 120 in FIG. 1) will determine (946) a period of time needed to finish the educational opportunity. For example, if a course runs for 6 hours a week for 12 weeks, the social networking system (e.g., system 120 in FIG. 1) will use that information to inform at least some of the estimated cost. For example, if the first member's current job pays fifteen dollars an hour, the social networking system (e.g., system 120 in FIG. 1) will estimate a cost of time based on this amount (or some discounted percentage based on this amount). If an educational opportunity will need the first member to become a full time student, the social networking system (e.g., system 120 in FIG. 1) will count the amount of income lost based on the total time.

Based on the monetary cost and the time needed to complete, the social networking system (e.g., system 120 in FIG. 1) estimates (948) a total cost associated with learning the respective skill.

In other example embodiments of estimating cost, the social networking system (e.g., system 120 in FIG. 1) generates (950) a list of members similar to the first member, wherein the each member in the list of similar members has at least one skill in common with the first member. In some example embodiments, the list of members is based on the group into which the first member was originally sorted.

In some example embodiments, the social networking system (e.g., system 120 in FIG. 1) determines (952), from the list of members similar to the first member, a total number of members who have the respective skill. Thus, if the social networking system (e.g., system 120 in FIG. 1) is determining the cost of adding Skill C, the social networking system (e.g., system 120 in FIG. 1) first determines how many of the members in the first member's Bucket have skill C.

FIG. 9E is a flow diagram illustrating a method, in accordance with some example embodiments, for personalizing skill recommendations to members of a social networking system. Each of the operations shown in FIG. 9E may correspond to instructions stored in a computer memory or computer-readable storage medium. Optional operations are indicated by dashed lines (e.g., boxes with dashed-line borders). In some embodiments, the method described in FIG. 9E is performed by the social networking system (e.g., system 120 in FIG. 1). However, the method described can also be performed by any other suitable configuration of electronic hardware.

In some embodiments the method is performed at a social networking system (e.g., system 120 in FIG. 1) including one or more processors and memory storing one or more programs for execution by the one or more processors.

In some example embodiments, the social networking system (e.g., system 120 in FIG. 1) calculates (954) a ratio of members in the list of members who have the respective skill to the total number of members in the list of members. In some example embodiments, the social networking system (e.g., system 120 in FIG. 1) determines that the rarer a skill is among similar members to the first member, the greater the cost to acquire it. Thus, when the ratio is low, the skill cost is high and when the ratio is high, the cost is low.

Based on the calculated ratio, the social networking system (e.g., system 120 in FIG. 1) estimates (956) the cost associated with learning the respective skill. The social networking system (e.g., system 120 in FIG. 1) subtracts (958) the cost associated with learning the respective skill from the benefit of learning the respective skill to determine a net value.

In some example embodiments, the social networking system (e.g., system 120 in FIG. 1) ranks each skill based on the skills determined net value. The social networking system (e.g., system 120 in FIG. 1) then orders the list of skills based on the ranking.

In some example embodiments, the social networking system (e.g., system 120 in FIG. 1) selects (960) one or more skills based on the determined value of each skill In some example embodiments, the one or more skills are selected based on the rankings/ordering of each skill.

For each selected skill, the social networking system (e.g., system 120 in FIG. 1) identifies (962) at least one educational opportunity associated with learning the selected skill. For example, the social networking system (e.g., system 120 in FIG. 1) has a database of educational opportunities and the skills being taught in each. Thus, the social networking system (e.g., system 120 in FIG. 1) searches the database for educational opportunities that allow the first member to learn a particular selected skill.

In some example embodiments, once a list of potential educational opportunities is determined, the social networking system (e.g., system 120 in FIG. 1) ranks the opportunities based on availability to the first member (e.g., limited to students enrolled at the educational institution, distance from member, and so on), cost, time (e.g., a four year program might not be possible for some members), and so on. The social networking system (e.g., system 120 in FIG. 1) selects one or more of the educational opportunities to recommend to the first member.

In some example embodiments, the social networking system. (e.g., system 120 in FIG. 1) transmits (964) a skill recommendation to a client system associated with the first member for display

FIG. 9F is a flow diagram illustrating a method, in accordance with some example embodiments, for personalizing skill recommendations to members of a social networking system. Each of the operations shown in FIG. 9F may correspond to instructions stored in a computer memory or computer-readable storage medium. Optional operations are indicated by dashed lines (e.g., boxes with dashed-line borders). In some embodiments, the method described in FIG. 9F is performed by the social networking system (e.g., system 120 in FIG. 1). However, the method described can also be performed by any other suitable configuration of electronic hardware.

In some embodiments the method performed at a social networking system (e.g., system 120 in FIG. 1) including one or more processors and memory storing one or more programs for execution by the one or more processors.

In some example embodiments, the social networking system (e.g., system 120 in FIG. 1) determines (970) a level of granularity of skill prediction. Thus, the skill prediction can be a narrow as a particular industry in a particular city or as broad as a field of technology in a state or more. The social networking system (e.g., system 120 in FIG. 1) determines the level of granularity based on the needs of the number of members and jobs listings in different level of granularity and based on whether there are any specific granularity requirements for the analysis (e.g., if a specific group or area is requested).

In some example embodiments, the social networking system (e.g., system 120 in FIG. 1) filters (972) members who match a selection criterion. Thus, only members who match the determined level of granularity with the specific criteria being used (i.e. belong to the specific city or industry) are included on the list.

In some example embodiments, the social networking system (e.g., system 120 in FIG. 1) aggregates (974) recommendations of skills to members in the filtered list to obtain a count of the number of times a skill was recommended using the utility-based recommendation system. A utility based recommendation system makes recommendation on the basis of the number and quality of employment opportunities for a particular skill.

In some example embodiments, the social networking system (e.g., system 120 in FIG. 1) makes (976) recommendations to the members in the filtered list based on a collaborative filtering system to obtain a count of the number of times a skill was recommended using the traditional similarity-based recommendation system. In some example embodiments, similarity based recommendation systems recommend skills based on the skill sets of similar members.

In some example embodiments, the social networking system (e.g., system 120 in FIG. 1) subtracts (978) the count of recommendations of a skill using the utility-based recommendation system (indicating skill demand through skill mentions in jobs) from the count of recommendations of a skill using the similarity-based recommendation system (indicating skill supply through skill popularity among members) to obtain skill gap score of the skill in question.

In some example embodiments, the social networking system (e.g., system 120 in FIG. 1) ranks and orders (980) skills by the skill gap score to obtain an ordered list of skills. In some example embodiments, the skill gap scores can be shared with public policy or educational institution stakeholders.

### Software Architecture

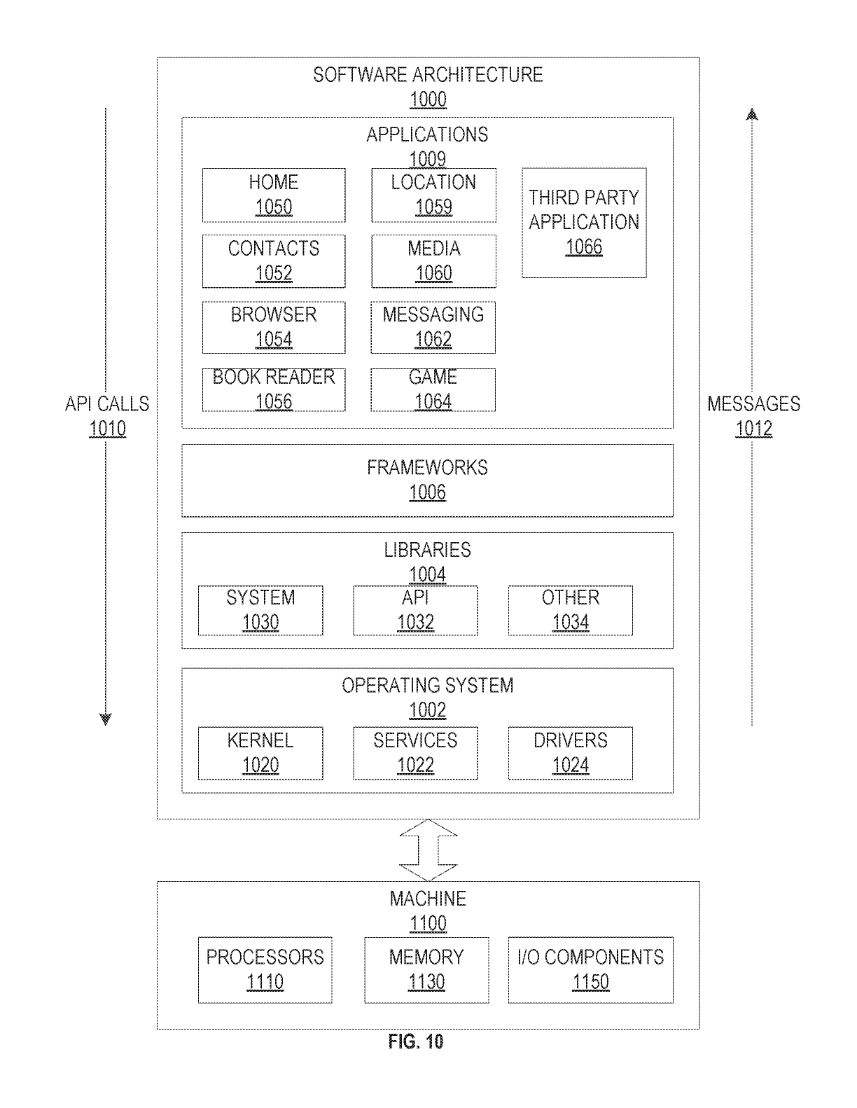

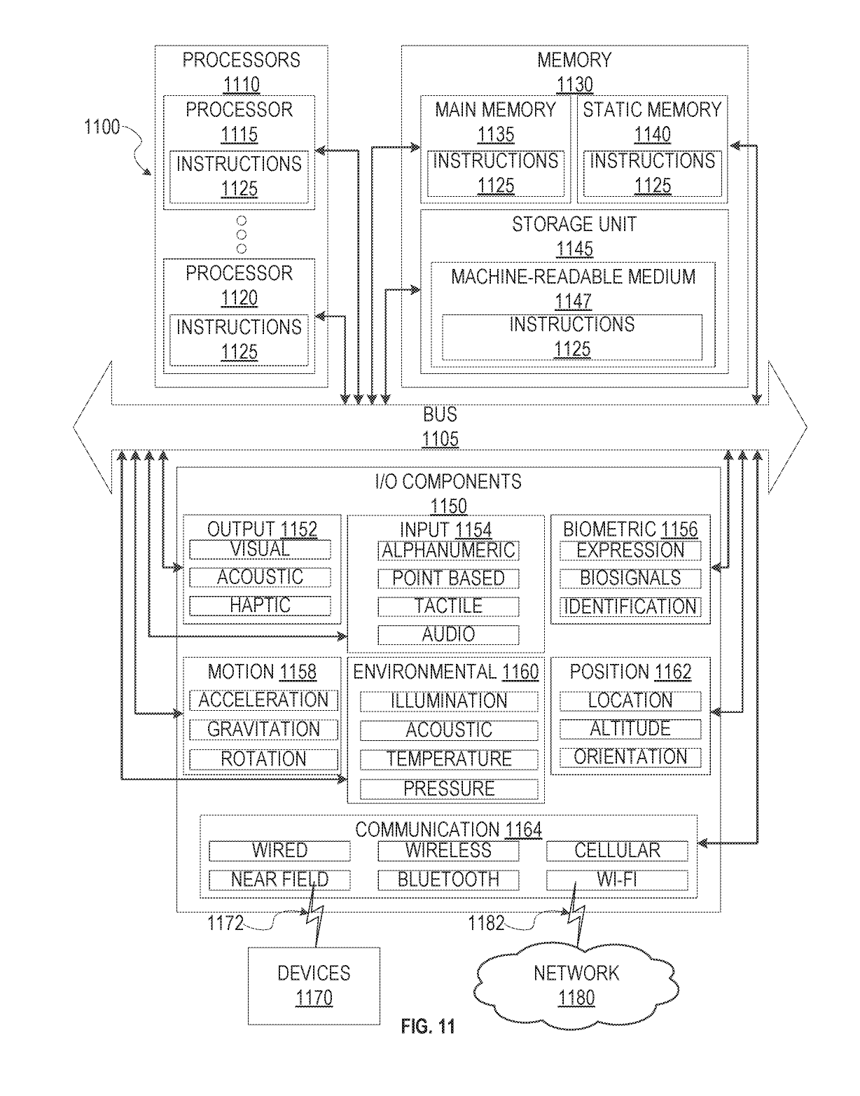

FIG. 10 is a block diagram illustrating an architecture of software 1000, which may be installed on any one or more of the devices of FIG. 1. FIG. 10 is merely a non-limiting example of an architecture of software 1000 and it will be appreciated that many other architectures may be implemented to facilitate the functionality described herein. The software 1000 may be executing on hardware such as a machine 1100 of FIG. 11 that includes processors 1110, memory 1130, and I/O components 1150. In the example architecture of FIG. 10, the software 1000 may be conceptualized as a stack of layers where each layer may provide particular functionality. For example, the software 1000 may include layers such as an operating system 1002, libraries 1004, frameworks 1006, and applications 1009. Operationally, the applications 1009 may invoke API calls 1010 through the software stack and receive messages 1012 in response to the API calls 1010.

The operating system 1002 may manage hardware resources and provide common services. The operating system 1002 may include, for example, a kernel 1020, services 1022, and drivers 1024. The kernel 1020 may act as an abstraction layer between the hardware and the other software layers. For example, the kernel 1020 may be responsible for memory management, processor management (e.g., scheduling), component management, networking, security settings, and so on. The services 1022 may provide other common services for the other software layers. The drivers 1024 may be responsible for controlling and/or interfacing with the underlying hardware. For instance, the drivers 1024 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth.

The libraries 1004 may provide a low-level common infrastructure that may be utilized by the applications 1009. The libraries 1004 may include system libraries 1030 (e.g., C standard library) that may provide functions such as memory allocation functions, string manipulation functions, mathematic functions, and the like. In addition, the libraries 1004 may include API libraries 1032 such as media libraries (e.g., libraries to support presentation and manipulation of various media formats such as MPEG4, H.264, MP3, AAC, AMR, JPG, PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 1004 may also include a wide variety of other libraries 1034 to provide many other APIs to the applications 1009.

The frameworks 1006 may provide a high-level common infrastructure that may be utilized by the applications 1009. For example, the frameworks 1006 may provide various graphical user interface (GUI) functions, high-level resource management, high-level location services, and so forth. The frameworks 1006 may provide a broad spectrum of other APIs that may be utilized by the applications 1009, some of which may be specific to a particular operating system 1002 or platform.

The applications 1009 include a home application 1050, a contacts application 1052, a browser application 1054, a book reader application 1056, a location application 1059, a media application 1060, a messaging application 1062, a game application 1064, and a broad assortment of other applications such as a third party application 1066. In a specific example, the third party application 1066 (e.g., an application developed using the Android™ or iOS™ software development kit (SDK) by an entity other than the vendor of the particular platform) may be mobile software running on a mobile operating system 1002 such as iOS™, Android™, Windows® Phone, or other mobile operating systems 1002. In this example, the third party application 1066 may invoke the. API calls 1010 provided by the mobile operating system 1002 to facilitate functionality described herein.

### Example Machine Architecture and Machine-Readable Medium

FIG. 11 is a block diagram illustrating components of a machine 1100, according to some example embodiments, able to read instructions from a machine-readable medium (e.g., a machine-readable storage medium) and perform any one or more of the methodologies discussed herein. Specifically, FIG. 11 shows a diagrammatic representation of the machine 1100 in the example form of a computer system, within which instructions 1125 (e.g., software 1100, a program, an application, an applet, an app, or other executable code) for causing the machine 1100 to perform any one or more of the methodologies discussed herein may be executed. In alternative embodiments, the machine 1100 operates as a standalone device or may be coupled (e.g., networked) to other machines. In a networked deployment, the machine 1100 may operate in the capacity of a server machine or a client machine in a server-client network environment, or as a peer machine in a peer-to-peer (or distributed) network environment. The machine 1100 may comprise, but be not limited to, a server computer, a client computer, a PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1125, sequentially or otherwise, that specify actions to be taken by the machine 1100. Further, while only a single machine 1100 is illustrated, the term “machine” shall also be taken to include a collection of machines 1100 that individually or jointly execute the instructions 1125 to perform any one or more of the methodologies discussed herein.

The machine 1100 may include processors 1110, memory 1130, and I/O components 1150, which may be configured to communicate with each other via a bus 1105. In an example embodiment, the processors 1110 (e.g., a CPU, a reduced instruction set computing (RISC) processor, a complex instruction set computing (CISC) processor, a graphics processing unit (GPU), a digital signal processor (DSP), an application specific integrated circuit (ASIC), a radio-frequency integrated circuit (RFIC), another processor, or any suitable combination thereof) may include, for example, a processor 1115 and a processor 1120, which may execute the instructions 1125. The term “processor” is intended to include multi-core processors 1110 that may comprise two or more independent processors 1115, 1120 (also referred to as “cores”) that may execute the instructions 1125 contemporaneously. Although FIG. 11 shows multiple processors 1110, the machine 1100 may include a single processor 1110 with a single core, a single processor 1110 with multiple cores (e.g., a multi-core processor), multiple processors 1110 with a single core, multiple processors 1110 with multiple cores, or any combination thereof.

The memory 1130 may include a main memory 1135, a static memory 1140, and a storage unit 1145 accessible to the processors 1110 via the bus 1105. The storage unit 1145 may include a machine-readable medium 1147 on which are stored the instructions 1125 embodying any one or more of the methodologies or functions described herein. The instructions 1125 may also reside, completely or at least partially, within the main memory 1135, within the static memory 1140, within at least one of the processors 1110 (e.g., within the processor's cache memory), or any suitable combination thereof, during execution thereof by the machine 1100. Accordingly, the main memory 1135, the static memory 1140, and the processors 1110 may be considered machine-readable media 1147.

As used herein, the term “memory” refers to a machine-readable medium 1147 able to store data temporarily or permanently and may be taken to include, but not be limited to, random-access memory (RAM), read-only memory (ROM), buffer memory, flash memory, and cache memory. While the machine-readable medium 1147 is shown, in an example embodiment, to be a single medium, the term “machine-readable medium” should be taken to include a single medium or multiple media (e.g., a centralized or distributed database, or associated caches and servers) able to store the instructions 1125. The term “machine-readable medium” shall also be taken to include any medium, or combination of multiple media, that is capable of storing instructions (e.g., instructions 1125) for execution by a machine (e.g., machine 1100), such that the instructions 1125, when executed by one or more processors of the machine 1100 (e.g., processors 1110), cause the machine 1100 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory (e.g., flash memory), an optical medium, a magnetic medium, other non-volatile memory (e.g., erasable programmable read-only memory (EPROM)), or any suitable combination thereof. The term “machine-readable medium” specifically excludes non-statutory signals per se.

The I/O components 1150 may include a wide variety of components to receive input, provide and/or produce output, transmit information, exchange information, capture measurements, and so on. It will be appreciated that the I/O components 1150 may include many other components that are not shown in FIG. 11. In various example embodiments, the I/O components 1150 may include output components 1152 and/or input components 1154. The output components 1152 may include visual components (e.g., a display such as a plasma display panel (PDP), light emitting diode (LED) display, a liquid crystal display (LCD), a projector, or a cathode ray tube (CRT)), acoustic components (e.g., speakers), haptic components (e.g., a vibratory motor), other signal generators, and so forth. The input components 1154 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, and/or other pointing instruments), tactile input components (e.g., a physical button, a touch screen that provides location and force of touches or touch gestures, and/or other tactile input components), audio input components (e.g., a microphone), and the like.

In further example embodiments, the I/O components 1150 may include biometric components 1156, motion components 1158, environmental components 1160, and/or position components 1162, among a wide array of other components. For example, the biometric components 1156 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, finger print identification, or electroencephalogram based identification), and the like. The motion components 1158 may include acceleration sensor components (e.g., accelerometer), gravitation sensor components, rotation sensor components (e.g., gyroscope), and so forth. The environmental components 1160 may include, for example, illumination sensor components (e.g., photometer), acoustic sensor components (e.g., one or more microphones that detect background noise), temperature sensor components (e.g., one or more thermometers that detect ambient temperature), humidity sensor components, pressure sensor components (e.g., barometer), proximity sensor components (e.g., infrared sensors that detect nearby objects), and/or other components that may provide indications, measurements, and/or signals corresponding to a surrounding physical environment. The position components 1162 may include location sensor components (e.g., a Global Position System (GPS) receiver component), altitude sensor components (e.g., altimeters and/or barometers that detect air pressure from which altitude may be derived), orientation sensor components (e.g., magnetometers), and the like.

Communication may be implemented using a wide variety of technologies. The I/O components 1150 may include communication components 1164 operable to couple the machine 1100 to a network 1180 and/or devices 1170 via a coupling 1182 and a coupling 1172, respectively. For example, the communication components 1164 may include a network interface component or another suitable device to interface with the network 1180. In further examples, the communication components 1164 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 1170 may be another machine 1100 and/or any of a wide variety of peripheral devices (e.g., a peripheral device coupled via a USB).

Moreover, the communication components 1164 may detect identifiers and/or include components operable to detect identifiers. For example, the communication components 1164 may include radio frequency identification (RFID) tag reader components, NFC smart tag detection components, optical reader components (e.g., an optical sensor to detect one-dimensional bar codes such as Universal Product Code (UPC) bar codes, multi-dimensional bar codes such as a Quick Response (QR) code, Aztec code, Data Matrix, Dataglyph, MaxiCode, PDF48, Ultra Code, UCC RSS-2D bar code, and other optical codes), acoustic detection components (e,g., microphones to identify tagged audio signals), and so on. In addition, a variety of information may be derived via the communication components 1164 such as location via Internet Protocol (IP) geo-location, location via Wi-Fi® signal triangulation, location via detecting an NFC beacon signal that may indicate a particular location, and so forth.

### Transmission Medium

In various example embodiments, one or more portions of the network 1180 may be an ad hoc network, an intranet, an extranet, a virtual private network (VPN), a LAN, a wireless LAN (WLAN), a WAN, a wireless WAN (WWAN), a MAN, the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 1180 or a portion of the network 1180 may include a wireless or cellular network and the coupling 1182 may be a Code Division Multiple Access (CDMA) connection, a Global System for Mobile communications (GSM) connection, or another type of cellular or wireless coupling. In this example, the coupling 1182 may implement any of a variety of types of data transfer technology, such as Single Carrier Radio Transmission Technology (1xRTT), Evolution-Data Optimized (EVDO) technology, General Packet Radio Service (CPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 1125 may be transmitted and/or received over the network 1180 using a transmission medium via a network interface device (e.g., a network interface component included in the communication components 1164) and utilizing any one of a number of well-known transfer protocols (e.g., HyperText Transfer Protocol (HTTP)). Similarly, the instructions 1125 may be transmitted and/or received using a transmission medium via the coupling 1172 (e.g., a peer-to-peer coupling) to the devices 1170. The term “transmission medium” shall be taken to include any intangible medium that is capable of storing, encoding, or carrying the instructions 1125 for execution by the machine 1100, and includes digital or analog communications signals or other intangible media to facilitate communication of such software 1000.

Furthermore, the machine-readable medium 1147 is non-transitory (in other words, not having any transitory signals) in that it does not embody a propagating signal. However, labeling the machine-readable medium 1147 as “non-transitory” should not be construed to mean that the medium is incapable of movement; the medium should be considered as being transportable from one physical location to another. Additionally, since the machine-readable medium 1147 is tangible, the medium may be considered to be a machine-readable device.

### Term Usage

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to he taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The foregoing description, for the purpose of explanation, has been described with reference to specific example embodiments. However, the illustrative discussions above are not intended to be exhaustive or to limit the possible example embodiments to the precise forms disclosed. Many modifications and variations are possible in view of the above teachings. The example embodiments were chosen and described in order to best explain the principles involved and their practical applications, to thereby enable others skilled in the art to best utilize the various example embodiments with various modifications as are suited to the particular use contemplated.

It will also be understood that, although the terms “first,” “second,” and so forth may be used herein to describe various elements, these elements should not be limited by these terms. These terms are only used to distinguish one element from another. For example, a first contact could be termed a second contact, and, similarly, a second contact could be termed a first contact, without departing from the scope of the present example embodiments. The first contact and the second contact are both contacts, but they are not the same contact.

The terminology used in the description of the example embodiments herein is for the purpose of describing particular example embodiments only and is not intended to be limiting. As used in the description of the example embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

1. A method comprising:
determining a list of skills not yet acquired by a first member of a social networking system based on his member profile;
determining a value associated with each skill;
selecting one or more skills from the list of skills based on the determined value of each skill;
for each selected skill, identifying at least one educational opportunity associated with learning the selected skill;
ranking the selected skills based on the determined value associate with each skill; and
transmitting a skill recommendation for an educational opportunity based on the selected skill rankings to a client system associated with the first member for display in a user interface.

2. The method of claim 1, wherein determining a value associated with each skill further comprises:
for each respective skill in the list of skills:
determining the benefit associated with learning the respective skill;
determining the cost associated with learning the respective skill; and
subtracting the cost associated with learning the respective skill from the benefit of learning the respective skill to determine a net value.

3. The method of claim 1, wherein determining a value associated with each skill further comprises:
determining a plurality of members similar to the first member based on member profile;
filtering the list of skills to include only skills that are held by at least one of the plurality of similar members but not by the first member;
for each respective skill in the list of skills:
determining the net benefit associated with learning the respective skill without consideration of the cost associated with learning the respective skill.

4. The method of claim 2, wherein determining a benefit associated with learning a respective skill further comprises:
based on the first member's current skill set, estimating an original number of employment opportunities available to the first member;
provisionally adding the respective skill to the first member's skill set;
based on the provisionally updated skill set, determining an updated number of employment opportunities available to the first member; and
comparing the original number of employment opportunities to the updated number of employment opportunities to determine an overall benefit to the learning the respective skill.

5. The method of claim 2, wherein determining a benefit associated with learning a respective skill further comprises:
determining one or more employment opportunities available to the first member based on the first member's current skill set;
based on the likelihood of success in applying for the one or more employment opportunities, generating an original expected salary increase for the first member;
provisionally adding the respective skill to the first member's skill set and determining one or more additional employment opportunities available to the first member based on the provisionally updated skill set;
based on the likelihood of success in applying for the one or more additional employment opportunities, generating an updated expected salary for the first member; and
subtracting the updated expected salary from the original expected salary to obtain an expected salary increase for determining a benefit associated with learning the respective skill.

6. The method of claim 2, determining a cost associated with learning the respective skill further comprises:
identifying one or more educational opportunities associated with learning the respective skill;
determining a monetary cost associated with the one or more educational opportunities;
determining a time needed to complete the educational opportunity;
based on the monetary cost and the time needed to complete, estimating a total cost associated with learning the respective skill.

7. The method of claim 2, determining a cost associated with learning the respective skill further comprises:
generating a list of members similar to the first member, wherein each member in the list of similar members has at least one skill in common with the first member;
determining, from the list of members similar to the first member, a total number of members who have the respective skill;
calculating a ratio of members in the list of members who have the respective skill to a total number of members in the list of members;
based on the calculated ratio, estimating the cost associated with learning the respective skill.

8. The method of claim 3, further comprising:
extracting of structured data fields from textual descriptions of unstructured job listings;
refining the extracted fields based on one or more curated data dictionaries.

9. The method of claim 3, further comprising:
sorting a plurality of members of the social networking system into one or more member groups, based on one or more member characteristics;
sorting a plurality of job listings available in a database of the social networking system into one or more job listing groups, based on one or more job listing data fields;
matching members to one or more job listings in linear time.

10. The method of claim 9, further comprising:
for a particular member group, determining one or more job listing groups that includes jobs appropriate for members in the particular member group;
further refining the extracted data fields of the jobs in the matched job listing groups based on the context of the matched member groups.

11. The method of claim 9, wherein determining whether a job listing group includes jobs appropriate for members in the particular member group comprises:
determining a percentage of job listings in the job listings group for which at least one member in the particular member listings group is a good candidate based on data stored in the member profile and job requirements listed in a job listing;
determining whether the percentage of job listings in the job listings group for which at least one member in the particular member listings group is a good candidate is above a predetermined threshold percentage; and
in accordance with a determination that the percentage of job listings in the job listings group for which at least one member in the particular member listings group is a good candidate is above a predetermined threshold percentage, selecting the job listings group as a match for the particular member listings group.

12. The method of claim 9, wherein the list of recommendable skills for the first member of a member group are determined, at least in part, based on the skills of the other members in the member group to which the first member was sorted.

13. The method of claim 9, wherein the estimated number of employment opportunities is determined based on the job listings in one or more job listing groups associated with the member group to which the first member has been sorted.

14. The method of claim 9, wherein selecting one or more skills as recommendations based on the determined value of each skill further comprises ranking and ordering the list of recommendable skills of the first member based on the value associated with the respective skill.

15. The method of claim 1, further comprising:
deciding a level of granularity of skill prediction;
filtering members who match a selection criterion to create a filtered list;
aggregating recommendations of skills to members in the filtered list to obtain a count of the number of times a skill was recommended using a utility based recommendation system;
making recommendations to the members in the filtered list based on a collaborative filtering system-to obtain a count of the number of times a skill was recommended using a similarly based recommendation system;
subtracting the count of recommendations of a skill using the utility-based recommendation system from the count of recommendations of a skill using the similarity-based recommendation system to obtain skill gap score of the skill in question; and
ranking and ordering skills by the skill gap score to obtain an ordered list of skills.

16. A system comprising:
one or more processors;
memory; and
one or more programs stored in the memory, he one or more programs comprising instructions for:
determining a list of skills not yet acquired by a first member of a social networking system based on his member profile;
determining a value associated with each skill;
selecting one or more skills from the list of skills based on the determined value of each skill;
for each selected skill, identifying at least, one educational opportunity associated with learning the selected skill;
ranking the selected skills based on the determined value associate with each skill; and
transmitting a skill recommendation for an educational opportunity based on the selected skill rankings to a client system associated with the first member for display in a user interface.

17. The system of claim 6, wherein determining a value associated with each skill further comprises:
for each respective skill in the list of skills:
determining the benefit associated with learning the respective skill;
determining the cost associated with learning the respective skill; and
subtracting the cost associated with learning the respective skill from the benefit of learning the respective skill to determine a net value.

18. The system of claim 17, wherein determining a benefit associated with learning a respective skill further comprises:
based on the first member's current skill set, estimating an original number of employment opportunities available to the first member;
provisionally adding the respective skill to the first member's skill set;
based on the provisionally updated skill set, determining an updated number of employment opportunities available to the first member; and
comparing the original number of employment opportunities to the updated number of employment opportunities to determine an overall benefit to the learning the respective skill.

19. A non-transitory computer-readable storage medium storing instructions that, when executed by the one or more processors of a machine, cause the machine to perform operations comprising:
determining a list of skills not yet acquired by a first member of a social networking system based on his member profile;
determining a value associated with each skill;
selecting one or more skills from the list of skills based on the determined value of each skill;
for each selected skill, identifying at least one educational opportunity associated with learning the selected skill;
ranking the selected skills based on the determined value associate with each skill; and
transmitting a skill recommendation for an educational opportunity based on the selected skill rankings to a client system associated with the first member for display in a user interface.

20. The non-transitory computer-readable storage medium of claim 19, wherein determining a value associated with each skill further comprises:
for each respective skill in the list of skills:
determining the benefit associated with learning the respective skill;
determining the cost associated with learning the respective skill; and
subtracting the cost associated with learning the respective skill from the benefit of learning the respective skill to determine a net value.
